(19) United States
(12) Patent Application Publication
(10) Pub. No.: US 2018/0370851 A1
(43) Pub. Date: Dec. 27, 2018

(54) INFRARED SHIELDING MATERIAL

(71) Applicant: FUJIFILM CORPORATION, Tokyo (JP)

(72) Inventors: Hirotoshi YOSHIZAWA, Kanagawa (JP); Hideki YASUDA, Kanagawa (JP); Takeharu TANI, Kanagawa (JP)

(21) Appl. No.: 16/116,923

(22) Filed: Aug. 30, 2018

Related U.S. Application Data
(63) Continuation of application No. PCT/JP2017/004831, filed on Feb. 9, 2017.

(30) Foreign Application Priority Data
Mar. 4, 2016 (JP) 2016-042367
Aug. 25, 2016 (JP) 2016-165038

(51) Int. Cl. C03C 17/36; B32B 17/06; C03C 17/00; C09D 5/33

(52) U.S. Cl. CPC C03C 17/3657; C09D 5/004; C03C 17/002; B32B 17/061

(57) ABSTRACT

An infrared shielding material includes a metal particle-containing layer containing flat sheet-like metal particles each having at least one hole.

### CROSS-REFERENCE TO RELATED APPLICATIONS

This application is a continuation application of International Application No. PCT/JP2017/004831, filed Feb. 9, 2017, the disclosure of which is incorporated herein by reference in its entirety. Further, this application claims priority from Japanese Patent Application No. 2016-042367, filed Mar. 4, 2016, and Japanese Patent Application No. 2016-165038, filed Aug. 25, 2016, the disclosures of which are incorporated herein by reference in their entirety.

### BACKGROUND OF THE INVENTION

### 1. Field of the Invention

The present invention relates to an infrared shielding material.

### 2. Description of the Related Art

In recent years, infrared shielding materials used for windows of automobiles, buildings, and the like have been developed as one of energy saving measures for reducing carbon dioxide emissions. The infrared shielding material includes an absorptive material that absorbs and re-radiates infrared rays (wavelength of 780 nm to 1 mm) and a reflective material that absorbs and re-radiates less light. In view of shielding efficiency, it is desirable that the infrared shielding material is a reflective material.

In a case of considering application to windows of automobiles, buildings, and the like, the infrared shielding material is required to have high transparency of the material and high shielding efficiency.

Various materials have been proposed as the infrared shielding material described above.

For example, a heat ray shielding material including a substrate, and a metal particle containing layer containing at least one kind of metal particles, in which the metal particles have 60% by number or more of hexagonal or disc-like metal flat sheet-like particles, and the principal plane of the metal flat sheet-like particles is plane-aligned in the range of 0° to ±30° with respect to one surface of the metal particle containing layer has been proposed (for example, see JP2011-118347A).

A far-infrared shielding material including a metal particle containing layer containing at least one kind of metal particles and 60% by number or more of flat sheet-like metal particles having hexagonal or circular metal particles, in which the ratio (B/A) of the maximum reflectance B (%) in the infrared range at a wavelength of 3 μm or more to the reflectance A (%) at the wavelength of 550 nm of the far-infrared shielding material is 3 or more has been proposed (see, for example, JP2014-56205A).

As an application example of flat sheet-like metal particles, a detection method of infiltrating one surface of gold particles formed in a ring shape into the solution and measuring near-infrared absorption of gold particles so as to detect a change of a solution or the like has been proposed (for example, see Phys. Rev. Lett. Vol. 90, No. 5, 057401 (2003), “Optical Properties of Gold Nanorings”).

### SUMMARY OF THE INVENTION

The infrared shielding material can be classified into a material that shields near-infrared rays (780 nm or more and less than 3,000 nm) and a material that shields far-infrared rays (3,000 nm to 1 mm) depending on the wavelength of infrared rays that the material reflects or absorbs. The material which shields near-infrared rays may be used as a material that obtains the effect of “heat shielding” that shields near-infrared rays arriving at the window of automobiles, buildings, and the like from an outside and suppresses temperature rise in the indoors. Meanwhile, the material that shields far-infrared rays may be used as a material which obtains an effect of “heat insulation” that prevents the heat of indoors of automobiles, buildings, and the like from flowing out of the window, that is, that shields far-infrared rays and prevents far-infrared rays from radiating to the outside. In recent energy saving measures, particularly, the material which obtains the effect of heat insulation of the latter is attracting attention.

The heat ray shielding material disclosed in JP2011-118347A is a material in which the shape and the like of metal particles are caused to be a specific shape so as to increase the reflectance of near-infrared rays, and the shielding of far-infrared rays has not been studied. Therefore, it is likely that the effect of heat insulation cannot be sufficiently obtained in the heat ray shielding material disclosed in JP2011-118347A.

In addition, regarding the ring-like gold particles disclosed in Phys. Rev. Lett. Vol. 90, No. 5, 057401 (2003), “Optical Properties of Gold Nanorings”, the change in absorption of near-infrared rays is observed, and the shielding of far-infrared rays has not been studied. Therefore, the effect of heat insulation in ring-like gold particles disclosed in Phys. Rev. Lett. Vol. 90, No. 5, 057401 (2003), “Optical Properties of Gold Nanorings” is unclear.

In a case where the infrared shielding material is applied to windows of automobiles and buildings, the infrared shielding material has high transparency (transmittance of visible light (wavelength of 350 nm or more and less than 780 nm)) and properties (radio wave transmitting properties) of transmitting radio waves of mobile phones, radios, and the like are required.

Although the far-infrared shielding material disclosed in JP2014-56205A is a material that shields (particularly, reflects) far-infrared rays and is also excellent in radio wave transmitting properties, the infrared shielding material disclosed in JP2014-56205A is required to increase the area ratio of the metal particles in the metal particle containing layer in order to obtain a high far-infrared reflectance. In the far-infrared shielding material disclosed in JP2014-56205A, in a case where the area ratio of metal particles in the metal particle containing layer is increased, the transmittance of visible light (350 nm or more and less than 780 nm) tends to decrease. That is, in the far-infrared shielding material disclosed in JP2014-56205A, the reflectance of far-infrared rays and the transmittance of visible light are in an antinomic relationship and thus tend to be difficult to achieve compatibility.

The present invention has been made in view of the above problems, and an object thereof is to provide an infrared shielding material having a high reflectance of far-infrared rays, high transparency, and high radio wave transmittance.

Specific means for solving the problems include the following aspects.

<1> An infrared shielding material, including a metal particle-containing layer containing flat sheet-like metal particles each having at least one hole.
<2> The infrared shielding material according to <1>, in which the metal particle-containing layer has an average value X_{AVE} of hole area ratios X each represented by the following Expression (1) of larger than 10% and less than 100%:

X=hole area/metal particle area×100 Expression (1)

in which, in Expression (1), X represents a hole area ratio, the hole area represents an area of the hole present in one flat sheet-like metal particle in a case where the flat sheet-like metal particle is viewed from a plane, and the metal particle area represents an area of one flat sheet-like metal particle in a case where the flat sheet-like metal particle is viewed from a plane.

<3> The infrared shielding material according to <2>, in which the average value X_{AVE} of the hole area ratios X of the metal particle containing layer is larger than 30% and less than 100%.
<4> The infrared shielding material according to <2> or <3>, in which the metal particle-containing layer has a surface density Y represented by the following Expression (2) and the average value X_{AVE} of the hole area ratios X satisfying the relationship represented by the following Expression (3):

Y=(total value of metal particle areas included in unit area)/(unit area)×100 Expression (2)

in which, in Expression (2), Y represents a surface density, and the metal particle areas each represent an area of one flat sheet-like metal particle in a case where the flat sheet-like metal particle is viewed from a plane:

Y≤0.75X_{AVE}+42.5 Expression (3).

<5> The infrared shielding material according to <4>, in which the surface density Y and the average value X_{AVE} of the hole area ratios X of the metal particle-containing layer satisfy the relationship represented by the following Expression (4):

Y≤0.75X_{AVE}+32.5 Expression (4).

<6> The infrared shielding material according to <4> or <5>, in which the surface density Y of the metal particle-containing layer is larger than 10% and less than 100%.
<7> The infrared shielding material according to any one of <4> to <6>, in which the surface density Y of the metal particle-containing layer is larger than 30% and less than 100%.
<8> The infrared shielding material according to any one of <1> to <7>, in which a coefficient of variation in particle diameter distribution of the flat sheet-like metal particles is 30% or less.
<9> The infrared shielding material according to any one of <1> to <8>, in which a cross section of one flat sheet-like metal particle in a case where the flat sheet-like metal particle is cut in a direction perpendicular to a principal plane thereof has an elliptical shape or a perfect circle shape.
<10> The infrared shielding material according to any one of <1> to <9>, in which an aspect ratio of a cross section of one flat sheet-like metal particle in a case where the flat sheet-like metal particle is cut in a direction perpendicular to a principal plane is 2.0 or less.
<11> The infrared shielding material according to any one of <1> to <10>, in which the flat sheet-like metal particles include at least silver.
<12> The infrared shielding material according to any one of <1> to <11>, in which, among the flat sheet-like metal particles, particles of which the principal planes are plane-aligned in a range of an average of 0°±30° with respect to one surface of the metal particle-containing layer are 50% by number of all flat sheet-like metal particles each having at least one hole.
<13> The infrared shielding material according to any one of <1> to <12>, in which a proportion of flat sheet-like metal particles each having at least one hole with respect to the total metal particles in the metal particle-containing layer is 60% by number or more.
<14> The infrared shielding material according to any one of <1> to <13>, in which a maximum value of a reflectance is in a wavelength range of from 0.78 μm to 1 mm.
<15> The infrared shielding material according to any one of <1> to <13>, in which a maximum value of a reflectance is in a wavelength range of from 3 μm to 1 mm.
<16> The infrared shielding material according to any one of <1> to <15>, in which a shape of one flat sheet-like metal particle in a case where the flat sheet-like metal particle is viewed from a plane is a polygonal shape of a hexagon or higher polygon, or a circular shape.
<17> The infrared shielding material according to any one of <1> to <16>, in which a shape of one flat sheet-like metal particle in a case where the flat sheet-like metal particle is viewed from a plane is a circular shape.
<18> The infrared shielding material according to any one of <1> to <17>, in which a shape of the hole in one flat sheet-like metal particle in a case where the flat sheet-like metal particle is viewed from a plane is a circular shape.
<19> The infrared shielding material according to any one of <1> to <18>, in which the number of holes included in one flat sheet-like metal particle is one.
<20> The infrared shielding material according to any one of <1> to <19>, in which a centroid of an entire flat sheet-like metal particle and a centroid of a hole in a case where one flat sheet-like metal particle is viewed from a plane are overlapped with each other.
<21> The infrared shielding material according to any one of <1> to <20>, in which the flat sheet-like metal particles are randomly arranged in the metal particle-containing layer.
<22> The infrared shielding material according to any one of <1> to <21>, in which an average particle diameter of the flat sheet-like metal particle is from 175 nm to 200 μm.

According to the present invention, there is provided an infrared shielding material having a high reflectance of far-infrared rays, a high transparency, and a high radio wave transmittance.

### BRIEF DESCRIPTION OF THE DRAWINGS

FIG. 1 is a schematic view of an upper surface of a flat sheet-like metal particle having a hole.

FIG. 2 is a schematic view of a cross section of the flat sheet-like metal particle having a hole.

FIG. 3 is an observation view of an upper surface of a metal particle containing layer of an infrared shielding material.

FIG. 4 is schematic cross-sectional view illustrating a presence state of the flat sheet-like metal particles having holes in the metal particle containing layer, and is a most ideal presence state.

FIG. 5 is a schematic cross-sectional view illustrating a presence state of the flat sheet-like metal particle having a hole in the metal particle containing layer and a diagram for describing an angle (θ) formed by a surface of the metal particle containing layer and a principal plane of the flat sheet-like metal particle having a hole.

FIG. 6 is a schematic cross-sectional view illustrating a presence state of the flat sheet-like metal particle having a hole in the metal particle containing layer and a diagram illustrating a presence region of the metal particle containing layer in a depth direction of the infrared shielding material.

FIG. 7 is a graph illustrating a reflectance and a transmittance of the flat sheet-like particle having a hole in Example 1 at a wavelength of 300 nm to 800 nm.

FIG. 8 is a graph illustrating the reflectance and the transmittance of the flat sheet-like particle having a hole in Example 1 at a wavelength of 2,000 nm to 5,000 nm.

FIG. 9 is a graph illustrating the reflectance and the transmittance of the flat sheet-like particle having a hole in Example 2 at a wavelength of 300 nm to 800 nm.

FIG. 10 is a graph illustrating the reflectance and the transmittance of the flat sheet-like particle having a hole in Example 2 at a wavelength of 2,000 nm to 5,000 nm.

FIG. 11 is a graph illustrating the transmittances of a flat sheet-like metal particle having a hole and a flat sheet-like metal particle not having a hole at a wavelength of 300 nm to 3,500 nm.

FIG. 12 is a graph illustrating the reflectances of the flat sheet-like metal particle having a hole and the flat sheet-like metal particle not having a hole at a wavelength of 300 nm to 3,500 nm.

FIG. 13 is a graph illustrating the absorbances of the flat sheet-like metal particle having a hole and the flat sheet-like metal particle not having a hole at a wavelength of 300 nm to 3,500 nm.

FIG. 14 is a graph illustrating a change of the reflectance at a wavelength of 300 nm to 4,000 nm due to the change of a coefficient of variation of the flat sheet-like metal particle having a hole.

FIG. 15 is a graph illustrating a change of the reflectance and the transmittance due to a change of the shape of the cross section of the flat sheet-like metal particle having a hole at a wavelength of 350 nm to 950 nm.

FIG. 16 is a graph illustrating changes of the reflectance and the transmittance due to a change of the aspect ratio of the cross section of the flat sheet-like metal particle having a hole at a wavelength of 350 nm to 950 nm.

FIG. 17 is an observation view of an upper surface of a flat sheet-like metal particle on a glass substrate.

FIG. 18 is a graph illustrating a reflectance of the infrared shielding material at a wavelength of 3,000 nm to 7,500 nm.

FIG. 19 is a graph illustrating a transmittance of the infrared shielding material at a wavelength of 2,500 nm to 7,500 nm.

FIG. 20 is a graph illustrating changes of the reflectance and the transmittance due to a change of the diameter of the flat sheet-like metal particle having a hole in a wavelength range of 300 nm or more.

FIG. 21 is a graph illustrating changes of the reflectance and the transmittance due to a (random/periodic) change of the arrangement state of the flat sheet-like metal particle having a hole in a wavelength range of a wavelength of 300 nm or more.

FIG. 22 is a graph illustrating changes of the reflectance and the transmittance due to a shape change (ring shape/square) of the flat sheet-like metal particle having a hole in a wavelength range of a wavelength of 300 nm or more.

FIG. 23 is a graph illustrating changes of the reflectance and the transmittance due to a refractive index change of a surrounding medium of the flat sheet-like metal particle having a hole in a wavelength range of a wavelength of 300 nm or more.

FIG. 24 is a conceptual diagram illustrating Range I and Range II.

### DESCRIPTION OF THE PREFERRED EMBODIMENTS

Hereinafter, an infrared shielding material of the present invention is specifically described.

According to the present specification, the numerical range expressed by using “to” means a range including numerical values described before and after “to” as a minimum value and a maximum value.

In the present specification, “(meth)acrylate” means at least one of acrylate or methacrylate. In the present specification, “(meth)acryl” means at least one of acryl or methacryl.

<Infrared Shielding Material>

An infrared shielding material has a metal particle containing layer containing a flat sheet-like metal particle having a hole.

The infrared shielding material may have a support, a protective layer, or the like, in addition to the metal particle containing layer.

An action of the present invention is not clear, but the present inventors assume as follows.

A metal particle used in an infrared shielding material in the related art is a hexagonal or circular flat sheet-like metal particle that does not have a hole and is designed to have a shape for efficiently shielding near-infrared rays, as illustrated in JP2011-118347A. As illustrated in JP2014-56205A, in a case where far-infrared rays are shielded by a hexagonal or circular flat sheet-like metal particle that does not have a hole, far-infrared rays are reflected by increasing an area ratio of a metal particle in a metal particle containing layer, a transmittance of visible light decreases, and thus the reflectance of far-infrared rays and the transmittance of visible light are not be compatible with each other.

The infrared shielding material of the present invention has a metal particle containing layer that contains a flat sheet-like metal particle having a hole. The flat sheet-like metal particle having a hole has two plasmon resonance peaks.

One is a peak caused by the entire particle including the hole portion of the particle, and this appears in a far-infrared range. That is, the infrared shielding material may efficiently reflect far-infrared rays in the wavelength range in which the peak appears.

Another one is a peak caused by a metal portion (for example, in a case where the particle has a ring shape having one hole, a width of the ring) other than the hole of the particle, and this appears in a range of a wavelength of 550 nm or less. The peak that appears in this wavelength of 550 nm or less shifts toward the shorter wavelength side than the shape of the metal portion other than the hole of the particle or the peak intensity is attenuated. That is, the flat sheet-like metal particle having a hole has no plasmon resonance peaks or low peak intensities in the visible range in a wavelength of 350 nm to 780 nm. Therefore, the transmittance of the visible light increases, and thus the transparency of the infrared shielding material increases.

The plasmon resonance peak that appears in the far-infrared range may appear with respect to a rod-like metal particle. However, in a case where a rod-like metal particle is used in a metal particle containing layer of an infrared shielding material, in a case where the rod-like metal particles in an amount required for sufficiently obtaining an infrared shielding effect are included in the metal particle containing layer, the rod-like metal particles come into contact with each other, so as to form an electric circuit in the layer. In a case where the electric circuit is formed in the layer, the layer hinders transmission of radio waves and, thus a high radio wave transmittance may not be obtained. In this point of view, since the infrared shielding material of the present invention uses the flat sheet-like metal particle having a hole in the metal particle containing layer, even in a case where the particles are included in the layer in a state of not being in contact with each other, an effect of shielding far-infrared rays may be obtained, and thus a layer that hardly hinders the transmission of the radio waves may be obtained.

Together with these, the present invention becomes an infrared shielding material having a high reflectance of far-infrared rays, high transparency, and a high radio wave transmittance.

[Metal Particle Containing Layer]

The infrared shielding material has a metal particle containing layer containing a flat sheet-like metal particle (hereinafter, also referred to as a specific metal particle) having a hole.

In a case where the infrared shielding material has a specific metal particle containing layer, the material may reflect far-infrared rays, and thus transparency and radio wave transmitting properties are also excellent. The metal particle containing layer contains at least one specific metal particle.

(Flat Sheet-Like Metal Particle Having Hole)

The flat sheet-like metal particle (specific metal particle) having a hole has a flat shape in a thickness direction and is a metal particle having a hole that penetrates in a thickness direction.

The specific metal particle is not particularly limited, but is a flat sheet-like particle having two principal planes. Examples thereof include a particle having at least one hole or a torus-like particle such as a donut shape, and the specific metal particle is appropriately selected according to the purpose.

With respect to the torus-like particle, in a case where the torus-like particle is left on the plane, a plane that comes into contact with the particle is set as a principal plane.

Examples of the shape of the specific metal particle include a triangular shape, a square shape, a hexagonal shape, an octagonal shape, and a circular shape. Among these, since the wavelength of far-infrared rays to be reflected may be easily controlled and the visible light transmittance is high, a polygonal shape of hexagon or higher or a circular shape is more preferable, and a circular shape is more preferable.

The shape of the specific metal particle means an outer shape in a case where the specific metal particle is viewed from a plane in a perpendicular direction to the principal plane.

The circular specific metal particles are not particularly limited, as long as the particle has a round shape without any corners in a case where specific metal particles are observed from the upper side (perpendicular direction) of the principal plane with a transmission electron microscope (TEM). The particle may be appropriately selected depending on the purpose.

The hexagonal specific metal particle is not particularly limited, as long as the particle has a hexagonal shape in a case where the flat sheet-like metal particle is observed from above (in the perpendicular direction) of the principal plane with a transmission electron microscope (TEM). The particle may be appropriately selected depending on the purpose. For example, hexagonal corners may be acute angles or obtuse angles, but in view of reducing the absorption of light in a visible range, obtuse angles are preferable. The angle is not particularly limited and may be appropriately selected depending on the purpose.

Among the specific metal particles that may be present in the metal particle containing layer, as the content proportion of the hexagonal or higher polygonal or circular flat sheet-like metal particles is higher, the content proportion is more preferable. The content proportion is preferably 60% by number or more, more preferably 65% by number or more, and particularly preferably 70% by number or more with respect to the total number of the specific metal particles. As the proportion of the flat sheet-like metal particle is 60% by number or more, the visible light transmittance increases.

The shape and the number of the holes of the specific metal particle is not particularly limited.

Examples of the shape of the hole include a triangular shape, square shape, a hexagonal shape, an octagonal shape, and a circular shape. Among these, the shape of the hole is preferably a circular shape, since the wavelength of the far-infrared rays to be reflected is easily controlled, and the visible light transmittance is high.

The number of holes may be one or two or more. Since the specific metal particle is easily manufactured, the number of holes is preferably one.

The shape of the hole of the specific metal particle means a shape of the hole in a case where the specific metal particle is viewed from a plane in a direction perpendicular to the principal plane.

With respect to the specific metal particle, since the shift amount of the plasmon resonance peak wavelength and the attenuation amount of the peak intensity are easily adjusted, the centroid of the entire particle and the centroid of the hole in a case where the specific metal particle is viewed from a plane in a perpendicular direction to the principal plane are preferably overlapped with each other.

In the present disclosure, the expression “the centroid of the entire particle and the centroid of the hole are overlapped with each other” means that the specific metal particles in which a distance between the centroid of the entire specific metal particle and the centroid of the hole is smaller than ¼ of an average particle diameter (average maximum length) of the specific metal particle are present by 70% by number or more with respect to the entire specific metal particles. It is not required that the centroid of the entire particle and the centroid of the hole completely coincide to each other.

Methods of measuring the centroid of the entire particle, the centroid of the hole, and the average particle diameter of the particle are described below.

The centroid of the entire particle means a point (indicated by D in Expression (5)) in which the relationship of Expression (5) is satisfied (a result of a volume portion on a left side becomes 0) in the shape of the specific metal particle.

∫_{D}(g−r)f(r)dV=0 Expression (5)

In Expression (5), g represents a vector of the centroid, r represents each coordinate vector of the particle plane, and f(r) represents the density of the coordinate vector r.

In the shape (indicated by Dₖ in Expression (6)) of the hole of the specific metal particle, the centroid of the hole means a point in which the relationship of Expression (6) is satisfied (a result of a volume portion on a left side becomes 0).

∫_{D}_{ₖ}(gₖ−rₖ)fₖ(rₖ)dVₖ=0 Expression (6)

In Expression (6), gₖ represents a vector of the centroid, rₖ represents each coordinate vector of the particle plane, and fₖ(rₖ) represents the density of the coordinate vector rₖ.

The specific metal particle has at least one hole. That is, the hole area ratio of the specific metal particle is greater than 0% and less than 100%.

The hole area ratio means a proportion (unit: %) of an area (area of hole) in a range surrounded by a circumference of a hole with respect to an area (area of specific metal particle) in a range surrounded by a circumference of the specific metal particle in a case where the specific metal particle is observed in a direction perpendicular to the principal plane. A hole area ratio X (%) of the specific metal particle is obtained by Expression (1).

X=hole area/metal particle area×100 Expression (1)

In Expression (1), X represents a hole area ratio, the hole area represents an area of a hole of one flat sheet-like metal particle in a case where the flat sheet-like metal particle is viewed from a plane, the metal particle area represents an area of one flat sheet-like metal particle in a case where the flat sheet-like metal particle is viewed from a plane.

The hole area ratio is specifically described with reference to a ring-like specific metal particle which is an aspect of the particle in which the shape of the specific metal particle is a circular shape and the shape of the hole is a circular shape.

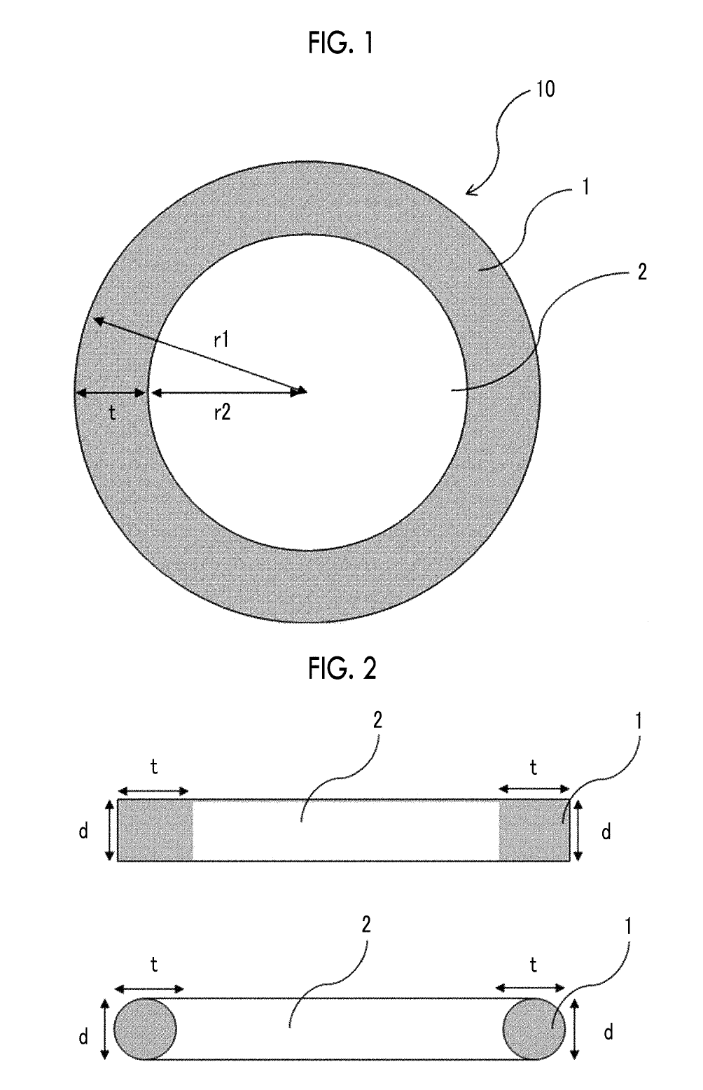

FIG. 1 illustrates a schematic view (top schematic view) in which the ring-like specific metal particles are observed in a perpendicular direction to the principal plane. A specific metal particle 10 in FIG. 1 is a flat sheet-like particle having a metal portion 1 and a hole portion 2 and having a radius r1 of the specific metal particle, a hole radius r2, and a width t of a metal portion.

The hole area ratio X of the specific metal particle is represented by a proportion (unit: %) of an area of the hole portion 2 with respect to the total area of the area of the metal portion 1 and the area of the hole portion 2 illustrated in FIG. 1.

As illustrated in FIG. 1, in a case where the specific metal particle has a ring shape, the hole area ratio X (%) may be obtained by Expression (1a).

X=π(r2)²/π(r1)²×100 Expression (1a)

In Expression (1a), X represents a hole area ratio, r1 represents a radius of a metal particle, and r2 represents a hole radius.

An average value X_{AVE} (hereinafter, referred to as the average hole area ratio X_{AVE}) of the hole area ratio X in the metal particle containing layer is an arithmetic mean value of the hole area ratio X of 200 random specific metal particles included in the metal particle containing layer, and is preferably greater than 10% and less than 100%.

In a case where the average hole area ratio X_{AVE} is greater than 10%, a peak (peak that appears in a range of a wavelength of 550 nm or less) on a shorter wavelength side due to the plasmon resonance of the specific metal particle is shifted to a shorter wavelength side or the intensity of the resonance peak attenuates regardless of the value of a surface density Y described below. Therefore, the transparency of the metal particle containing layer increases.

In the above point of view, the average hole area ratio X_{AVE} is more preferably greater than 30% and less than 100% and even more preferably 50% or more and less than 100%.

A shape of the cross section of the specific metal particle is not particularly limited.

The shape of the cross section of the specific metal particle refers to a shape of a metal portion in a case where the specific metal particle is cut in a perpendicular direction with respect to the principal plane of the specific metal particle.

FIG. 2 illustrates a schematic view (schematic cross-sectional view) of a cross-sectional shape of a specific metal particle. The specific metal particle illustrated in FIG. 2 has the metal portion 1 and the hole portion 2 and has the width t of the metal portion 1 in a parallel direction to the principal plane of the specific metal particle and a height d of the metal portion 1 in a perpendicular direction to a principal plane.

The shape of the cross section of the specific metal particle may be observed by an atomic force microscope (AFM).

The shape of the cross section of the specific metal particle may be a square shape, may be a perfect circle shape, or may be an elliptical shape. The shape may be a shape in which a part of these is missing.

The shape of the cross section of the specific metal particle influences on a wavelength in which the peak (peak that appears in the range of a wavelength of 550 nm or less) on the shorter wavelength side due to the plasmon resonance of the specific metal particle appears. As the shape of the cross section of the specific metal particle comes closer to a perfect circle shape, the peak on the shorter wavelength side due to the plasmon resonance is shifted to the shorter wavelength side by the wavelength of 550 nm, or the intensity of the resonance peak attenuates. Therefore, the transparency of the metal particle containing layer increases.

Therefore, the shape of the cross section of the specific metal particle is preferably an elliptical shape or a perfect circle shape and more preferably a perfect circle shape.

The method of observing the cross section of the specific metal particle is not particularly limited, and may be appropriately selected depending on the purpose.

For example, the method may be a method of manufacturing an appropriate cross-sectional slice and observing a cross section of this section so as to perform evaluation. Specific examples thereof include a method of manufacturing cross-sectional samples or cross-sectional slice samples of the specific metal particles embedded in a resin by using a microtome or a focused ion beam (FIB), observing the samples by using various microscopes (for example, a field emission scanning electron microscope (FE-SEM)), and evaluating the samples from the obtained images. Here, a cutting position in a case of manufacturing the cross-sectional slice sample is a position that can be cut in a perpendicular direction to the principal plane along a straight line connecting the centroid of the entire particle and the centroid of the hole.

The aspect ratio (the width t/the height d in FIG. 2) of the cross section of the specific metal particle also influence on the wavelength in which the peak (peak that appears in the range of the wavelength of 550 nm or less) on the shorter wavelength side due to the plasmon resonance of the specific metal particle appears.

As the aspect ratio of the cross section of the specific metal particle decreases, the peak on the shorter wavelength side due to the plasmon resonance is shifted to the shorter wavelength side than the wavelength of 550 nm or the intensity of the resonance peak attenuates. Therefore, the transparency of the metal particle containing layer increases.

Therefore, the aspect ratio of the cross section of the specific metal particle is preferably 2.0 or less and more preferably 1.5 or less.

The aspect ratio is preferably 0.1 or more and more preferably 0.15 or more.

The aspect ratio of the cross section of the specific metal particle may be measured by an atomic force microscope (AFM).

The aspect ratio may be obtained as an arithmetic mean of aspect ratios measured from 200 random specific metal particles.

The average particle diameter (maximum length) of the specific metal particle is not particularly limited and may be appropriately selected depending on the purpose, and the average particle diameter is preferably 175 nm or more and more preferably 275 nm or more. In a case where the average particle diameter is 175 nm or more and preferably 275 nm or more, the contribution of absorption of the specific metal particles is smaller than reflection, and thus far-infrared rays may be efficiently reflected.

The average particle diameter is preferably 200 μm or less, more preferably 150 μm or less, and even more preferably 100 μm or less. In a case where the average particle diameter is 200 μm or less and more preferably 100 μm or less, the average particle diameter becomes the human eye resolution (0.1 mm to 0.2 mm) or less, and thus the transparency may be further increased. In a case where the average particle diameter is set as above, the far-infrared rays having a wavelength of 3 μm to 100 μm that are radiated from a substance at about room temperature (about 300 K) may be efficiently reflected.

The average particle diameter in the present specification means an average value of a maximum length of 200 specific metal particles arbitrarily selected from an image obtained by observing the particles with a transmission electron microscope (TEM).

The maximum length refers to a maximum value in a distance of two random points on the principal plane of the specific metal particle.

In view of the ease of manufacturing and the visible light transmittance, the thickness of the specific metal particle is preferably 5 nm to 120 nm, more preferably 7 nm to 80 nm, and particularly preferably from 10 nm to 40 nm.

In a case where the thickness of the metal particles is within the above range, absorption and reflection characteristics of visible light by the metal particles are suppressed, and thus an infrared shielding material excellent in the visible light transmittance may be obtained.

The aspect ratio of the entire specific metal particle is not particularly limited, and may be appropriately selected depending on the purpose.

The aspect ratio of the entire specific metal particle refers to a value obtained by dividing an average particle diameter (average maximum length) of the outer shapes of the specific metal particles by an average value of the thicknesses of the specific metal particle.

The coefficient of variation in the particle diameter distribution of the specific metal particles is preferably 30% or less and more preferably 10% or less.

In a case where the coefficient of variation is 30% or less, the far-infrared rays in a desired wavelength may be efficiently reflected.

The lower limit of the coefficient of variation is not particularly limited and may be 0% or more.

The coefficient of variation may be obtained based on the actual measurement value. A coefficient of variation V (%) may be obtained by measuring particle diameters of 100 specific metal particles from an image of a scanning electron microscope (SEM), setting the average value as an average particle diameter (average maximum length), and dividing the standard deviation of the particle diameters in the particle diameter distribution by particle diameters of 100 specific metal particles with the average particle diameter (average maximum length).

V=Standard deviation particle diameter in particle diameter distribution/average particle diameter(average maximum length)×100

In a case where the physical properties of the specific metal particles are calculated by simulation, the coefficient of variation (%) may be combined as an initial set value.

The material of the specific metal particle is not particularly limited and may be appropriately selected depending on the purpose. Specifically, at least one metal element selected from the group consisting of the fourth period, the fifth period, and the sixth period of the periodic table (IUPAC 1991) is preferable, at least one metal element selected from the group consisting of Groups 2 to 14 is more preferable, at least one metal element selected from the group consisting of Groups 2, 8, 9, 10, 11, 12, 13, and 14 is even more preferable, and it is particularly preferable to include these metal elements as a main component. The main component refers to a component contained by the content ratio of 50 mass % or more with respect to the total mass of the specific metal particles.

Specific examples of the metal element include silver, gold, aluminum, copper, rhodium, nickel, platinum, tin, cobalt, palladium, iridium, iron, ruthenium, osmium, manganese, molybdenum, tungsten, niobium, tantalum, titanium, bismuth, antimony, cadmium, chromium, zinc, and lead.

Among these, in view of a far-infrared reflectance, silver, gold, aluminum, copper, rhodium, nickel, platinum, tin, cobalt, palladium, and iridium are preferable, silver, gold, aluminum, copper, rhodium, nickel, and platinum are more preferable, and silver is particularly preferable.

These metal elements may be included singly, or two or more kinds thereof may be used in combination.

The material of the specific metal particle may be an alloy including two or more kinds of metal and may be a metal oxide.

—Surface Density—

The metal particle containing layer includes specific metal particles. That is, the surface density (unit: %) which is a proportion of a total value of the occupied areas of the range surrounded by the circumference of the specific metal particle with respect to the total projected area of the metal particle containing layer in a case of being viewed from a plane in the perpendicular direction to the metal particle containing layer is greater than 0% and less than 100%.

In the present specification, the surface density, for example, may be measured by processing SEM images obtained by observation by a SEM in the perpendicular direction to the metal particle containing layer.

The surface density Y (%) of the metal particle containing layer is obtained by Expression (2).

Y=(total value of metal particle area contained in unit area)/(unit area)×100 Expression (2)

In Expression (2), Y represents the surface density, and the metal particle area represents an area of one flat sheet-like metal particle in a case where the flat sheet-like metal particle is viewed from a plane.

The surface density is more specifically described below with reference to the case where the specific metal particle has a ring shape.

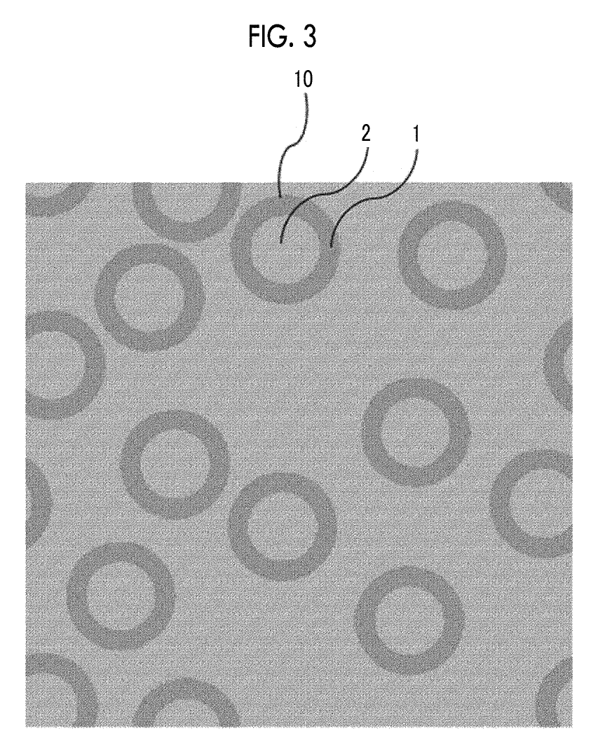

FIG. 3 illustrates an image obtained by observation in the perpendicular direction to the metal particle containing layer in the specific metal particle. FIG. 3 illustrates the metal portion 1 and the hole portion 2 of the specific metal particle 10 in the observation range.

As illustrated in FIG. 3, in a case where the specific metal particle has a ring shape, the surface density Y (%) in the metal particle containing layer may be obtained by Expression (2a).

Y=π(radius of specific metal particle)×the number of specific metal particles per unit area Expression (2a)

The surface density Y of the metal particle containing layer is preferably more than 10% and less than 100%.

In a case where the surface density is more than 10%, the reflectance in the far-infrared range increases regardless of the values of the average hole area ratio X_{AVE} of the specific metal particles.

In view of the above, the surface density Y is more preferably more than 30% and less than 100% and even more preferably 50% or more and less than 100%.

The average hole area ratio X_{AVE} and the surface density Y of the specific metal particles preferably satisfy the relationship of Expression (3) and more preferably satisfy the relationship of Expression (4).

Y≤0.75X_{AVE}+42.5 Expression (3)

Y≤0.75X_{AVE}+32.5 Expression (4)

In a case where the relationship of X_{AVE} and Y satisfies Expression (3), the transmittance of the visible range further increases.

—Plane Alignment—

In the infrared shielding material, it is preferable that the principal planes of the specific metal particles are plane-aligned to one surface of the metal particle containing layer in a predetermined range.

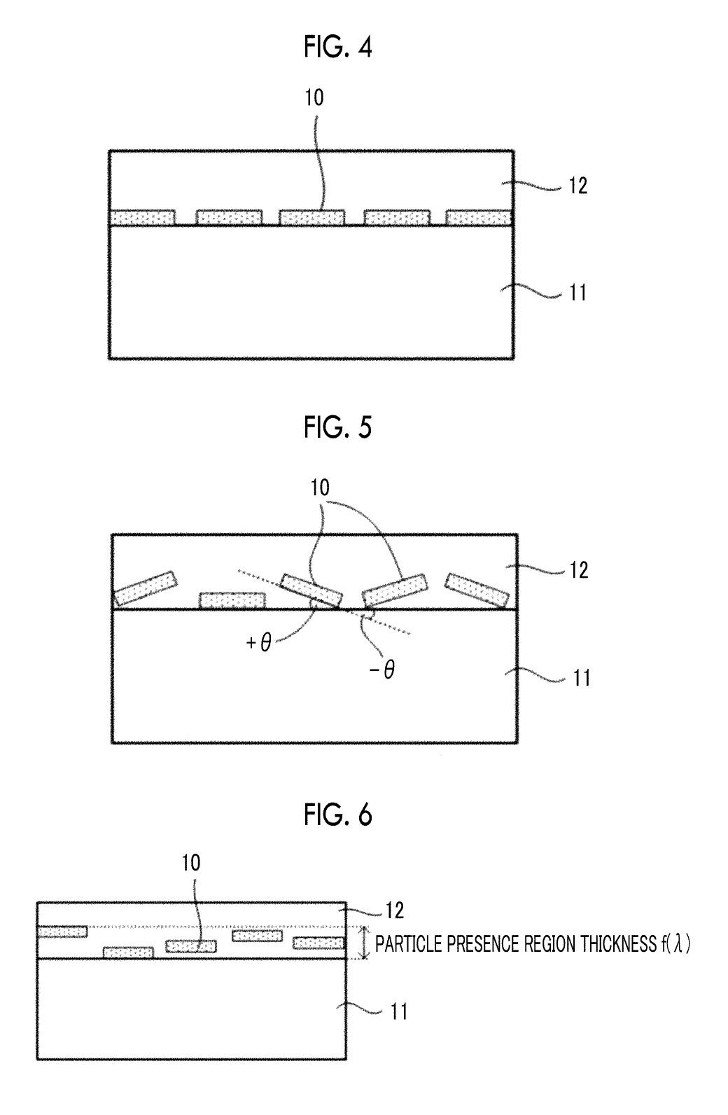

FIGS. 4 to 6 are schematic cross-sectional views illustrating presence states of the specific metal particles in the metal particle containing layer. FIG. 4 illustrates a most ideal presence state of the specific metal particle 10 in a metal particle containing layer 12. FIG. 5 is a diagram describing an angle (±θ) formed by a plane of the support 11 and a plane of the specific metal particle 10. FIG. 6 is a presence region in a depth direction of an infrared shielding material of the metal particle containing layer 12.

In FIG. 5, the angle (±θ) formed by the surface of the support 11 and the principal plane of the specific metal particle 10 or an extension line of the principal plane corresponds to a predetermined range in the plane alignment. That is, the plane alignment refers to a state in which an inclination angle (±θ) illustrated in FIG. 5 is small in a case where the cross section of the infrared shielding material is observed, and particularly, FIG. 4 illustrates a state in which the surface of the support 11 and the principal plane of the specific metal particle 10 are in contact with each other, that is, a state in which θ is 0°. In a case where the angle of the plane alignment of the principal plane of the specific metal particle 10 with respect to the surface of the support 11, that is, θ in FIG. 5 is ±30° or less, and the reflectance in the far-infrared range further increases.

As the plane alignment, an angle of the plane alignment that is formed by the principal plane of the specific metal particle and one surface of the metal particle containing layer is preferably 0° to ±30° and more preferably 0° to ±20°.

Particularly, among the specific metal particles, the particle in which the principal plane is plane-aligned in the range of 0°±30° with respect to one surface of the metal particle containing layer is preferably 50% by number or more of the entire specific metal particles.

The evaluation on whether the principal plane of the specific metal particle with respect to the surface of the metal particle containing layer is plane-aligned is particularly limited and may be appropriately selected depending on the purpose. For example, a method of manufacturing an appropriate cross-sectional slice and observing the metal particle containing layer and the specific metal particle in this slice so as to perform evaluation may be used.

Specific examples thereof include a method of manufacturing a cross-sectional sample or a cross-sectional slice sample of an infrared shielding material by using an infrared shielding material by a microtome and a focused ion beam (FIB) and observing the sample by using various microscopes (for example, a field emission scanning electron microscope (FE-SEM)) from the obtained image, so as to perform evaluation.

In the infrared shielding material, in a case where the specific metal particle is coated with a binder and the binder swells with water, a cross-sectional sample or a cross-sectional slice sample may be manufactured by cutting a sample in a state of being frozen with liquid nitrogen with a diamond cutter attached to a microtome. In the infrared shielding material, in a case where the binder with which the specific metal particle is coated does not swell with water, a cross-sectional sample or a cross-sectional slice sample may be manufactured.

The observation of the cross-sectional sample or the cross-sectional slice sample manufactured as above is not particularly limited, as long as whether the principal plane of the specific metal particle with respect to the surface of the metal particle containing layer in the sample is plane-aligned may be checked. The observation may be appropriately selected depending on the purpose. Specific examples thereof include observation using FE-SEM, TEM, an optical microscope, or the like.

In a case of the cross-sectional sample, the observation may be performed by FE-SEM, and in a case of the cross-sectional slice sample, the observation may be performed by TEM. In a case where the evaluation is performed by FE-SEM, it is preferable to have a spatial resolution capable of clearly determining the shape of specific metal particles and the inclination angle (±θ in FIG. 5).

—Average Inter-Particle Distance of Specific Metal Particles—

The average inter-particle distance of the specific metal particles that are adjacent to each other in the horizontal direction in the metal particle containing layer is preferably 1/10 or more of the average particle diameter of the specific metal particle, in view of the reflectance of the far-infrared rays and the visible light transmittance.

In a case where the average inter-particle distance of the specific metal particles in the horizontal direction is 1/10 or more of the average particle diameter of the specific metal particles, the reflectance of the far-infrared rays further increases. In view of the visible light transmittance of the average inter-particle distance in the horizontal direction is preferably uneven (random). In a case where the visible light transmittance is not random, that is, even, diffraction due to the specific wavelength occurs, and thus the transparency decreases in some cases.

The average inter-particle distance in the horizontal direction may be obtained by subtracting the average particle diameter from the average particle center-to-center distance in the horizontal direction described below.

In the specific metal particle, the average particle center-to-center distance in the horizontal direction means an average value of the center-to-center distance between two adjacent particles. The center-to-center distance may be obtained by observing the specific metal particles with a scanning electron microscope (SEM) in a perpendicular direction to the principal plane, taking a captured SEM image into analysis software (for example, ImageJ), and measuring the center-to-center distance of the adjacent metal particles. Specifically, after the SEM image is binarized, the outline of the specific metal particle is detected, the even thickness of the specific metal particle is assumed, barycentric coordinates of the metal particles are obtained, and distances between barycentric coordinates of adjacent specific metal particles are obtained, so as to measure the center-to-center distance.

A random average particle center-to-center distance means that in a case where a two-dimensional autocorrelation of the brightness values in a case of binarizing an SEM image including 100 or more specific metal particles is obtained, the SEM image has no significant maximum point other than the original point.

—Presence Region of Specific Metal Particle—

As illustrated in FIG. 6, in the infrared shielding material, in a case where plasmon resonance wavelength of metal that forms the specific metal particle 10 in the metal particle containing layer 12 is set as λ, a refractive index of a medium in the metal particle containing layer 12 is set as n, it is preferable that the metal particle containing layer 12 is present in the range of (λ/n)/4 in the depth direction from the horizontal plane of the infrared shielding material. In a case where the metal particle containing layer 12 is present in the range, the effect of strengthening the amplitudes of the reflected waves increases by the phase of the reflected wave at the interface between the upper and lower metal particle containing layers of the infrared shielding material, the haze characteristics, the visible light transmittance, and the infrared maximum reflectance are improved.

The metal particle containing layer may include metal particles in addition to the specific metal particles.

With respect to the metal particle containing layer, in view of the far-infrared reflectance, the visible light transmittance, and the radio wave transmittance of the infrared shielding material, the proportion of the flat sheet-like metal particle having the hole is preferably 60% by number or more with respect to the total included metal particles.

˜Method of Manufacturing Specific Metal Particle˜

The method of manufacturing the specific metal particle is not particularly limited as long as the flat sheet-like metal particle having a hole is obtained in the method, and the method may be appropriately selected depending on the purpose.

Examples of the method of manufacturing the specific metal particle include a liquid phase method such as a chemical reduction method, a photochemical reduction method, and an electrochemical reduction method, a physical method such as a vacuum deposition method, a sputtering method, and an ion plating method, and a chemical method such as chemical vapor deposition (CVD), and a plasma CVD method. Among these, in view of controlling shapes and sizes, a physical method is preferable.

As the method of manufacturing the specific metal particle, in addition to the above, crystals of the metal particles (for example, Ag) may be grown in a flat sheet shape after seed crystals are previously fixed on the surface of a transparent substrate such as a film or glass.

As the method of manufacturing the specific metal particle, for example, disclosures in Nano Lett 2011, 11, 3893-3898, Ultrafast Vibrations of Gold Nanorings and Nano Lett 2007, 7, 1256-1263, Sensing Characteristics of NIR Localized Surface Plasmon Resonances in Gold Nanorings for Application as Ultrasensitive Biosensors may be referred to.

In the infrared shielding material, in order to further providing desired characteristics, a further treatment may be performed on the specific metal particle. The further treatment is not particularly limited and may be appropriately selected depending on the purpose. Examples thereof include formation of high refractive index shell layer disclosed in Paragraphs [0068] to [0070] of JP2014-184688A and addition of various additives disclosed in Paragraphs [0072] to [0073] of JP2014-184688A.

(Binder of Metal Particle Containing Layer)

The metal particle containing layer may include a binder.

The binder is not particularly limited and may be appropriately selected depending on the purpose. The infrared shielding material preferably includes a polymer as a binder of the metal particle containing layer more preferably includes a transparent polymer. Examples of the polymer include a polymer such as a polyvinyl acetal resin, a polyvinyl alcohol resin, a polyvinyl butyral resin, a (meth)acrylic resin, a polycarbonate resin, a polyvinyl chloride resin, a (saturated) polyester resin, a urethane resin, and a natural polymer such as gelatin and cellulose.

Among these, it is preferable that the main component of the polymer is at least one of a polyvinyl alcohol resin, a polyvinyl butyral resin, a polyvinyl chloride resin, a (saturated) polyester resin, or a urethane resin.

In the present specification, the main component of the polymer is a polymer component occupying 50 mass % or more of the polymer included in the binder.

The content of the polyvinyl butyral resin is preferably 1 mass % to 10,000 mass %, more preferably 10 mass % to 1,000 mass %, and particularly preferably 20 mass % to 500 mass % with respect to the mass of the specific metal particles included in the metal particle containing layer. In a case where the binder included in the metal particle containing layer is in the above range or more, physical properties such as rubbing resistance may be further improved.

A refractive index n of the binder is preferably 1.1 or more, more preferably 1.3 or more, and particularly preferably 1.4 to 1.7. As the refractive index of the surrounding medium is increased, the wavelength (peak wavelength) exhibiting the maximum reflection in the infrared range may be shifted to the longer wavelength side. By this effect, it is possible to have a function of efficiently reflecting far-infrared rays with a wavelength of 3 μm to 100 μm, which are significantly emitted from a substance of about room temperature (about 300 K) in metal particles having a small average particle diameter (average maximum length). That is, a metal amount used in the manufacturing of the metal particle may be reduced.

With respect to the infrared shielding material, in a case where the thickness of the specific metal particle is set as a, it is preferable that a/10 or more of the thickness direction is covered with the polymer, it is more preferable that the a/10 to 10×a of the thickness direction is covered with the polymer, and it is particularly preferable that a/8 to 4×a is covered with the polymer with respect to 80% by number or more of the specific metal particles. In this manner, since the specific metal particles are buried in the metal particle containing layer by a certain proportion or more, rubbing resistance may be further increased.

(Other Additives)

As the other additives, the metal particle containing layer may include a crosslinking agent, a surfactant, an antioxidant, and a dispersing agent.

The crosslinking agent is not particularly limited, and examples thereof include an epoxy-based crosslinking agent, an isocyanate-based crosslinking agent, a melamine-based crosslinking agent, a carbodiimide-based crosslinking agent, and an oxazoline-based crosslinking agent. Among these, a carbodiimide-based crosslinking agent and an oxazoline-based crosslinking agent are preferable. Specific examples of the carbodiimide-based crosslinking agent include CARBODILITE (registered trademark) V-02-L2 (manufactured by Nisshinbo Chemical Inc.). It is preferable that the content of the component derived from the crosslinking agent is preferably 1 mass % to 20 mass % and more preferably 2 mass % to 20 mass % with respect to the total binder in the metal particle containing layer.

As the surfactant, known surfactants such as an anionic surfactant or a nonionic surfactant can be used. Specific examples of the surfactant include RAPIZOL (registered trademark) A-90 (manufactured by NOF Corporation), NAROACTY (registered trademark) CL-95 (manufactured by Sanyo Chemical Industries, Ltd.), and RIPAL 870P (Lion Corporation). The metal particle containing layer contains the surfactant preferably by 0.05 mass % to 10 mass % and more preferably 0.1 mass % to 5 mass % with respect to the content of the total binder in the metal particle containing layer.

The metal particle containing layer may include an antioxidant such as mercaptotetrazole or ascorbic acid in order to prevent oxidation of metal such as silver forming specific metal particles. For the purpose of preventing oxidation, an oxidation sacrificial layer of nickel (Ni) or the like may be formed on the surfaces of the specific metal particles. For the purpose of blocking oxygen, the specific metal particles may be coated with a metal oxide film such as SiO₂.

Examples of the dispersing agent include a dispersing agent such as a low molecular weight dispersing agent including at least one of a nitrogen element such as quaternary ammonium salt and amines, a sulfur element, or a phosphorus element, and a high molecular weight dispersing agent.

˜Physical Properties of Metal Particle Containing Layer˜

The metal particle containing layer preferably has a maximum value of the reflectance in a range of the wavelength of 0.78 μm to 1 mm and more preferably has a maximum value of the reflectance in a range of the wavelength of 3 μm to 1 mm.

In a case where the metal particle containing layer has the maximum value of the reflectance in the above range, far-infrared rays may be more efficiently reflected.

The reflectances and the transmittances of the light in the far-infrared range and the visible range of the metal particle containing layer may be adjusted by changing particle shapes, particle diameters, particle thicknesses, and particle line widths in the specific metal particle, the surface density of the specific metal particles, most adjacent inter-metal particle distances, and numerical values of the coefficients of variation.

Reflection spectra and transmission spectra of the light in the far-infrared range and the visible range of the metal particle containing layer may be obtained by the simulation below.

—Modeling Metal Particle Single Layer Arrangement—

As parameters to be used for creating a simulation model, shapes, cross-sectional shapes, particle diameters, particle thicknesses, particle line widths, and hole area ratios of the specific metal particles, surface density of the specific metal particles, most adjacent inter-metal particle distances, and coefficient of variation are input.

Subsequently, the positions in the horizontal plane of the specific metal particle are randomly arranged so as to satisfy the condition that other specific metal particles are not present in a distance less than the most adjacent inter-metal particle distance.

Specifically, in a case where an n-th particle is arranged, in a case where the particle is arranged in a specific coordinate determined by a random number generated by a calculator, distances to the entire 1 to (n−1)-th specific metal particles are measured, and the distances to the entire specific metal particles are the most adjacent inter-metal particle distance or more, which satisfy the condition, the n-th particle is arranged at the position. In a case where any one specific metal particle is present in a distance of less than the most adjacent inter-metal particle distance, the position is discarded, and the arrangement position is determined such that a flat sheet-like metal particle having an n-th hole in another coordinate newly generated is present.

With respect to the all specific metal particles, an algorithm for repeating the determination of the above arrangement position is performed, and the specific metal particles are arranged until the specific metal particles satisfy the set area ratio, so as to obtain a specific metal particle model of a random structure.

In a case where a random structure in which the specific metal particles do not contact each other as described above is employed, an electric circuit is not formed in the metal particle containing layer, and the infrared shielding material may maintain high surface electrical resistance. That is, the above model has excellent radio wave transmitting properties.

For the thickness direction of the metal particle containing layer, a simulation model is created under the condition that the metal particles are present at the same height as a single layer.

—Simulation by FDTD Method—

With respect to the random arrangement structure of the specific metal particle of the simulation model created above, spectral (transmission, reflection, and absorption) spectra in the visible range and the far-infrared range are calculated by an electromagnetic field optical simulation FDTD (finite-difference time-domain) method.

As the input parameters to the model, the spectral characteristics of the complex refractive index of the flat sheet-like metal particle having holes and the surrounding medium are input.

As the complex refractive index of the specific metal particle, for example, fitting is performed on silver (Ag) with the Drude model to the complex refractive index disclosed in P. B. Johnson and R. W. Christy, Optical Constants of the Noble Metals, Phys. Rev. B6, 4370 to 4379 (1972), and the values of the complex refractive indexes calculated in the wavelength of 300 nm to 50 μm at intervals of 5 nm may be used.

The calculation of the spectral spectrum may be performed by the FDTD method in the range required for the optical characteristics in the wavelength range of the wavelength of 300 nm to 50 μm.

The thickness of the metal particle containing layer is preferably 1 time to 500 times, more preferably 1 time to 100 times, and even more preferably 1 time to 50 times of the average value of the thicknesses of the metal particles.

˜Forming of Metal Particle Containing Layer˜

The method of forming the metal particle containing layer is not particularly limited and may be appropriately selected depending on the purpose. Examples of the method of coating the surface of the support with a dispersion liquid for forming a metal particle containing layer by a dip coater, a die coater, a slit coater, a bar coater, and a gravure coater and performing plane alignment by a Langmuir-Blodgett film (LB film) method, a self-assembly method, or a method of spray coating or the like.

In order to promote the plane alignment, after the dispersion liquid for forming a metal particle containing layer is coated, the plane alignment may be promoted by a crimp roller such as a calendar roller and a laminating roller.

The metal particle containing layer may be formed by previously arranging the specific metal particles on the surface of the support and then applying the binder.

The dispersion liquid for forming a metal particle containing layer may contain an antifoaming agent and a preservative.

In preparation or redispersion of specific metal particles, a reaction liquid and a coarse dispersion liquid may be vigorously stirred. Though depending on the properties of a target liquid, foams are stabilized by the presence of substances that lower the surface tension, and thus foaming may be promoted by causing the specific metal particle dispersion liquid to contain a surfactant, a dispersing agent, and the like. Therefore, it is preferable to contain an antifoaming agent.

As the defoaming agent, a general antifoaming agent such as a surfactant, a polyether antifoaming agent, an ester-based antifoaming agent, a higher alcohol-based antifoaming agent, a mineral oil-based antifoaming agent, and a silicone-based antifoaming agent may be selected to be used. Among them, the surfactant is preferably used because a high antifoaming effect may be exhibited by the addition of a small amount, and temporal stability is excellent.

In a case of being used in an aqueous system, a surfactant having high lipophilicity and easily spreading on the liquid surface, that is, a surfactant having a low hydrophile-lipophile balance (HLB) value is preferably used. In a case of being used in an aqueous system, the HLB value is preferably 7 or less, more preferably 5 or less, and most preferably 3 or less.

As the antifoaming agent, a commercially available antifoaming agent may be used, and for example, Pluronic 31R1 (manufactured by BASF SE) or the like may be preferably used.

As the preservative, for example, preservatives disclosed in Paragraphs [0073] to [0090] of JP2014-184688A may be used.

[Support]

The infrared shielding material preferably has a support.

The support is particularly limited, and well-known supports may be used.

As the support, an optically transparent support is preferable, and examples thereof include a support having a visible light transmittance of 70% or more and preferably 80% or more, and a support having a high transmittance of a near-infrared range.

The visible light transmittance may be measured by using an ultraviolet-visible near-infrared spectrometer (V-670, manufactured by JASCO Corporation, using an integrating sphere unit ISN-723).

The shape, the structure, the size, the material, and the like of the support are not particularly limited and may be appropriately selected depending on the purpose. Examples of the shape include a flat sheet shape, and the structure thereof may have a single layer structure or may have a lamination layer structure. The size thereof may be appropriately selected according to the size of the infrared shielding material.

The material of the support is not particularly limited and may be appropriately selected depending on the purpose, and examples thereof include materials such as glass such as white plate glass and blue plate glass; polyolefin such as polyethylene, polypropylene, poly 4-methylpentene-1, and polybutene-1; polyester such as polyethylene terephthalate (PET) and polyethylene naphthalate; and a cellulose resin such as polycarbonate, polyvinyl chloride, polyphenylene sulfide, polyethersulfone, polyethylene sulfide, polyphenylene ether, polystyrene, a (meth)acrylic resin, a polyamide resin, a polyimide resin, and triacetyl cellulose (TAC), and a laminated material thereof. Among these, a polyethylene terephthalate material is particularly preferable.

The thickness of the support is not particularly limited and may be appropriately selected depending on the application purpose of the infrared shielding material. The thickness is generally about 10 μm to 500 μm, but a thinner support is preferable in view of thinning the film. The thickness of the support is preferably 10 μm to 100 μm, more preferably 20 μm to 75 μm, and particularly preferably 35 μm to 75 μm. In a case where the thickness of the support is sufficiently thick, adhesion failure hardly occurs.

In a case where the thickness of the support is sufficiently thin, in a case where the support is laminated as an infrared shielding material on a building material or a window glass of an automobile, the stiffness as a material is not too high and construction becomes easy in some cases. In a case where the support is sufficiently thin, the visible light transmittance increases, and thus the cost of raw materials may be suppressed.

[Protective Layer]

The infrared shielding material may have a protective layer (hereinafter, also referred to as a hard coat layer) including an inorganic particle on at least one surface side of the metal particle containing layer.

In a case where the infrared shielding material is produced in a roll, in a case where the infrared shielding material has a protective layer, the slipperiness with the adjacent layer may be easily adjusted in an appropriate range, and wrinkles and roll collapse at the time of winding the roll hardly occur.

In a case where the infrared shielding material has a protective layer, the scratch resistance of the infrared shielding material increases, and the decrease of the transparency caused by the scratch on the infrared shielding material may be suppressed.

(Inorganic Particle)

The protective layer preferably including at least one kind of inorganic particles.

Examples of the inorganic particle include metal oxide particles. As specific examples of the metal oxide particles, particles of silica, alumina, zirconia, titania, and the like are preferably used, and particularly, silica particles are preferably used in view of crosslinking to the binder described below.

As the silica particles, dry powder-like silica manufactured by combustion of silicon tetrachloride, or colloidal silica in which silicon dioxide or a hydrate thereof is dispersed in water may be used. In a case where dry powder-like silica is used, the silica may be used by dispersing the silica in water using an ultrasonic disperser or the like.

The silica particle is not particularly limited, and specific examples thereof include a SEAHOSTAR series (manufactured by Nippon Shokubai Co., Ltd.) such as SEAHOSTAR KE-P10 or a SNOWTEX (registered trademark) series (manufactured by Nissan Chemical Industries, Ltd.) such as SNOWTEX (registered trademark) OZL-35.

The average particle diameter of the inorganic particles is preferably 60 nm to 350 nm, more preferably 65 nm to 300 nm, and even more preferably 70 nm to 250 nm.

In a case where the average particle diameter of the inorganic particle is 60 nm or more, the anti-blocking properties of the protective layer are easily obtained. In a case where an average particle diameter of the inorganic particle is as large as 350 nm or less, the scattering of light may be suppressed in the film or on the film surface, and thus the transparency of the layer is further enhanced.

The average particle diameter (unit: μm) of the inorganic particle may be obtained by imaging a scanning electron micrograph (SEM image) of 100 inorganic particles by a scanning electron microscope (for example, S-3700N, manufactured by Hitachi High-Technologies Corporation), and measuring particle diameters thereof by using an image processing measuring device (LUZEX AP, manufactured by Nireco Corporation), so as to obtain an arithmetic mean value. That is, in a case where the projected shape of the inorganic particle is circular, the average particle diameter of the inorganic particle is represented by a diameter, and in a case where the projected shape is an irregular shape other than the circular shape, the average particle diameter is represented by a diameter in a case of a circle having the same area as the projected area.

The content of the inorganic particle in the protective layer is preferably 30 volume % or more, more preferably 35 volume % or more, and even more preferably 40 volume % or more with respect to the total solid content of the protective layer. The content of the inorganic particle is preferably 60 volume % or less, more preferably 55 volume % or less, and even more preferably 50 volume % or less.

In a case where two or more kinds of the inorganic particles may be used in combination. In this case, the sum of the total kinds used is in the above range.

(Binder of Protective Layer)

The protective layer preferably includes a binder.

The binder may be an inorganic binder or may be an organic binder. In view of the scratch resistance of the protective layer, the binder is preferably an inorganic binder.

Examples of the inorganic binder include a binder that is cured and includes epoxy group-containing alkoxysilane, epoxy group-free alkoxysilane, and a metal complex.

As the alkoxysilane (hereinafter, the epoxy group-containing alkoxysilane and the epoxy group-free alkoxysilane are collectively referred to as “alkoxysilane”), a water-soluble or water-dispersible material is preferably used. In view of reducing environmental pollution due to volatile organic compounds (VOC), it is preferable to use a water-soluble or water-dispersible material.

It is preferable that the epoxy group-containing alkoxysilane and the epoxy group-free alkoxysilane each have a hydrolyzable group. The hydrolyzable group is hydrolyzed in an acidic aqueous solution to generate silanol, and silanol condenses with each other to form an oligomer.

The content proportion of the epoxy group-containing alkoxysilane is preferably 20 mass % to 100 mass % with respect to the total amount of the alkoxysilane. The lower limit of the content proportion of the epoxy group-containing alkoxysilane is preferably 25 mass % or more and more preferably 30 mass % or more. The upper limit thereof is more preferably 90 mass % or less, even more preferably 85 mass % or less, and even more preferably 80 mass % or less. In a case where the content proportion of the epoxy group-containing alkoxysilane with respect to the total amount of alkoxysilane is in the above range, it is advantageous for improving the stability of the composition in a case of preparing the aqueous composition for forming the protective layer and it is easy to form a protective layer having strong alkali resistance.

The epoxy group-containing alkoxysilane is alkoxysilane having an epoxy group. The epoxy group-containing alkoxysilane may alkoxysilane having one or more epoxy group in one molecule, and the number of epoxy groups is not particularly limited. In addition to the epoxy group, epoxy group-containing alkoxysilane may further have a group such as an alkyl group, an amide group, a urethane group, a urea group, an ester group, a hydroxy group, and a carboxy group.

Examples of the epoxy group-containing alkoxysilane include 2-(3,4-epoxycyclohexyl) ethyltrimethoxysilane, 2-(3,4-epoxycyclohexyl) ethyltriethoxysilane, 2-(3,4-epoxycyclohexyl) ethyltriethoxysilane, 2-(3,4-epoxycyclohexyl) ethylmethyldimethoxysilane, 2-(3,4-epoxycyclohexyl) ethylmethyldiethoxysilane, 3-glycidoxypropyltrimethoxysilane, and 3-glycidoxypropyltriethoxysilane. Examples of commercially available products include KBE-403 (manufactured by Shin-Etsu Chemical Co., Ltd.).

The epoxy group-free alkoxysilane is alkoxysilane having no epoxy group. The epoxy group-free alkoxysilane may be alkoxysilane having no epoxy group and may have a group such as an alkyl group, an amide group, a urethane group, a urea group, an ester group, a hydroxy group, and a carboxyl group.

Examples of the epoxy group-free alkoxysilane include tetraalkoxysilane, trialkoxysilane, and a mixture thereof, and tetraalkoxysilane is preferable. In a case where the epoxy group-free alkoxysilane has tetraalkoxysilane, sufficient hardness may be obtained in a case where the protective layer is formed.

Tetraalkoxysilane is tetrafunctional alkoxysilane, and it is preferable that the number of carbon atoms of the alkoxy group is more preferably 1 to 4. Among these, tetramethoxysilane and tetraethoxysilane are particularly preferably used. In a case where the number of carbon atoms is set to 4 or less, the hydrolysis rate of the tetraalkoxysilane in a case of being mixed with acidic water does not become too slow, and the time required for dissolving until an even aqueous solution is obtained becomes shorter. This may increase the manufacturing efficiency in a case where the protective layer is formed. Examples of commercially available products include KBE-04 (manufactured by Shin-Etsu Chemical Co., Ltd.).

Trialkoxysilane is trifunctional alkoxysilane represented by Formula (A).

RSi(OR¹)₃ (A)

Here, R represents an organic group including no amino group and having 1 to 15 carbon atoms, and R¹ represents an alkyl group having 4 or less carbon atoms such as a methyl group and an ethyl group.

The trifunctional alkoxysilane represented by Formula (A) does not include an amino group as a functional group. That is, this trifunctional alkoxysilane has an organic group R having no amino group. In the case where R has an amino group, in a case where the trifunctional alkoxysilane is mixing with tetrafunctional alkoxysilane and hydrolyzed, dehydration condensation is promoted by generated silanol. It is not preferable that the protective layer is formed by adjusting the aqueous composition for forming the protective layer, because the aqueous composition becomes unstable.

R of Expression (A) may be an organic group having a molecular chain length such that the number of carbon atoms is in the range of 1 to 15, and examples thereof include a vinyl group, methacryloxypropyl, a methacryloxypropylmethyl group, an acryloxy propyl group, a mercaptopropyl group, and a mercaptopropylmethyl group. In a case where the number of carbon atoms is set to 15 or less, the flexibility in a case where the protective layer is formed does not become excessively large, and sufficient hardness may be obtained. In a case where the number of carbon atoms of R is set to the above range, it is possible to obtain a protective layer with improved brittleness. It is possible to increase adhesion between the protective layer and an adjacent layer (for example, the support).

The organic group represented by R may have a heteroatom such as oxygen, nitrogen, and sulfur. In a case where the organic group has a heteroatom, it is possible to enhance the adhesion to the adjacent layer.

Examples of the trialkoxysilane include vinyl trimethoxysilane, 3-methacryloxypropyl trimethoxysilane, 3-acryloxypropyl trimethoxysilane, 3-chloropropyl trimethoxysilane, 3-ureidopropyl trimethoxysilane, propyl trimethoxysilane, phenyl trimethoxysilane, vinyl triethoxysilane, 3-methacryloxypropyl triethoxysilane, 3-acryloxypropyl triethoxysilane, 3-chloropropyl triethoxysilane, 3-ureidopropyl triethoxysilane, methyl triethoxysilane, methyl trimethoxysilane, ethyl triethoxysilane, ethyl trimethoxysilane, propyl triethoxysilane, propyl trimethoxysilane, phenyl triethoxysilane, and phenyl trimethoxysilane. Among these, methyl triethoxysilane and methyl trimethoxysilane are particularly preferably used. Examples of commercially available products include KBE-13 (manufactured by Shin-Etsu Chemical Co., Ltd.).

(Metal Complex)

The protective layer preferably contains a metal complex as a curing agent. As the metal complex, a metal complex including a metal element selected from aluminum, magnesium, manganese, titanium, copper, cobalt, zinc, hafnium, and zirconium is preferable, and these metal complexes may also be used in combination.

These metal complexes may be easily obtained by reacting metal alkoxide with a chelating agent. As examples of the chelating agent, β-diketone such as acetylacetone, benzoylacetone, and dibenzoylmethane and β-keto acid ester such as ethyl acetoacetate and ethyl benzoylacetate may be used, and aluminum chelate is preferable.

Preferable specific examples of the metal complex include an aluminum chelate compound such as ethyl acetoacetate aluminum diisopropylate, aluminum tris(ethyl acetoacetate), alkyl acetoacetate aluminum diisopropylate, aluminum monoacetyl acetate bis(ethyl acetoacetate), and aluminum tris(acetylacetonate), a magnesium chelate compound such as ethyl acetoacetate magnesium monoisopropylate, magnesium bis(ethyl acetoacetate), alkyl acetoacetate magnesium monoisopropylate, and magnesium bis(acetylacetonate), zirconium tetraacetylacetonate, zirconium tributoxyacetylacetonate, zirconium acetylacetonate bis(ethyl acetoacetate), manganese acetylacetonate, cobalt acetylacetonate, copper acetylacetonate, titanium acetylacetonate, and titanium oxyacetylacetonate. Among these, aluminum tris(acetylacetonate), aluminum tris(ethyl acetoacetate), magnesium bis(acetylacetonate), magnesium bis(ethyl acetoacetate), and zirconium tetraacetylacetonate are preferable. In view of preservation stability and considering availability, aluminum tris(acetylacetonate), aluminum tris(ethyl acetoacetate), aluminum bisethylacetoacetate-monoacetylacetonate, and the like which are aluminum chelate complexes are particularly preferable. Examples of commercially available products include aluminum chelate A (W), aluminum chelate D, and aluminum chelate M (manufactured by Kawaken Fine Chemical Co., Ltd.), and the like.

The metal complex is preferably used in an amount of 20 mass % to 70 mass %, more preferably used in an amount of 30 mass % to 60 mass %, and even more preferably used in an amount of 40 mass % to 50 mass % with respect to the total amount of the alkoxysilane.

In a case where the protective layer includes the metal complex by the lower limit value or more, the reaction rate of the dehydration condensation of silanol may be set as an appropriate rate, and a protective layer having an even thickness and high alkali resistance may be obtained.

(Other Additives)

The protective layer may include a surfactant for the purpose of improving the slipperiness of the surface and reducing the friction of the layer surface.

As the surfactant, various kinds of surfactants such as a fluorine-based surfactant, a nonionic surfactant, a cationic surfactant, an anionic surfactant, and a silicone-based surfactant may be used.

Examples of the fluorine-containing surfactant include MEGAFACE (registered trademark) F171, MEGAFACE F172, MEGAFACE F173, MEGAFACE F176, MEGAFACE F177, MEGAFACE F141, MEGAFACE F142, MEGAFACE F143, MEGAFACE F144, MEGAFACE R30, MEGAFACE F437, MEGAFACE F475, MEGAFACE F479, MEGAFACE F482, MEGAFACE F554, MEGAFACE F780, and MEGAFACE F781 (above, manufactured by DIC Corporation), FLUORAD FC430, FLUORAD FC431, and FLUORAD FC171 (above, manufactured by Sumitomo 3M Limited), SURFLON (registered trademark) S-382, SURFLON SC-101, SURFLON SC-103, SURFLON SC-104, SURFLON SC-105, SURFLON SC1068, SURFLON SC-381, SURFLON SC-383, SURFLON S393, and SURFLON KH-40 (above, manufactured by Asahi Glass Co., Ltd.), and PF636, PF656, PF6320, PF6520, and PF7002 (manufactured by OMNOVA Solutions Inc.).

Specific examples of the nonionic surfactant include glycerol, trimethylolpropane, trimethylolethane, and ethoxylates and propoxylates thereof (for example, glycerol propoxylate and glycerin ethoxylate), polyoxyethylene lauryl ether, polyoxyethylene stearyl ether, polyoxyethylene oleyl ether, polyoxyethylene octyl phenyl ether, polyoxyethylene nonylphenyl ether, polyethylene glycol dilaurate, polyethylene glycol distearate, and sorbitan fatty acid ester, PLURONIC L10, L31, L61, L62, 10R5, 17R2, and 25R2, TETRONIC 304, 701, 704, 901, 904, and 150R1 (manufactured by BASF SE), PIONIN D-6512, D-6414, D-6112, D-6115, D-6120, D-6131, D-6108-W, D-6112-W, D-6115-W, D-6115-X, and D-6120-X (manufactured by Takemoto Oil & Fat Co., Ltd.), SOLSPERSE 20000 (manufactured by Japan Lubrizol Corporation), and NAROACTY (registered trademark) CL-95 and HN-100 (manufactured by Sanyo Chemical Industries, Ltd.).

Specific examples of the cationic surfactant include phthalocyanine derivatives (Trade name: EFKA-745 manufactured by Morishita Industry Co., Ltd.), an organosiloxane polymer KP341 (manufactured by Shin-Etsu Chemical Co., Ltd.), a (meth)acrylic (co)polymer POLYFLOW No. 75, No. 90, and No. 95 (manufactured by Kyoeisha Chemical Co., Ltd.), and W001 (Yuso Co., Ltd.).

Specific examples of the anionic surfactant include W004, W005, and W017 (Yusho Co., Ltd.), and SANDET (registered trademark) BL (manufactured by Sanyo Chemical Industries Ltd.).

Examples of the silicone surfactant include “Toray Silicone DC3PA”, “Toray Silicone SH7PA”, “Toray Silicone DC11PA”, “Toray Silicone SH21PA”, “Toray Silicone SH28PA”, “Toray Silicone SH29PA”, “Toray Silicone SH30PA”, and “Toray Silicone SH8400” manufactured by Dow Corning Toray Co., Ltd., “TSF-4440”, “TSF-4300”, “TSF-4445”, “TSF-4460”, and “TSF-4452”, manufactured by Momentive Performance Materials Inc., “KP341”, “KF6001”, and “KF6002” manufactured by Shin-Etsu Chemical Co., Ltd., and “BYK307”, “BYK323”, and “BYK330” manufactured by BYK Japan K.K.

Only one type of surfactant may be used, or two or more types thereof may be used in combination.

The addition amount of the surfactant is preferably 0.001 mass % to 10.0 mass %, more preferably 0.005 mass % to 10.0 mass %, and even more preferably 1 mass % to 8 mass % with respect to the total mass of the protective layer.

For the surfactant, a pH adjusting agent may be added to an aqueous composition (an aqueous composition for forming a protective layer) which is adjusted in order to form the protective layer such that pH becomes within a desired range.

The pH adjusting agent is not particularly limited, as long as pH is changed. Specific examples thereof include acid (organic acid, inorganic acid) such as nitric acid, oxalic acid, acetic acid, formic acid, and hydrochloric acid, and alkali such as ammonia, triethylamine, ethylenediamine, sodium hydroxide, and potassium hydroxide. The pH adjusting agent may be added directly or as a solution such as an aqueous solution. The usage amount of the pH adjusting agent is not particularly limited as long as pH satisfies the desired range.

It is preferable that pH of the aqueous composition is adjusted to be 2 to 6. As the pH adjusting agent, nitric acid, oxalic acid, acetic acid, formic acid, and hydrochloric acid are preferable, and acetic acid is particularly preferable.

˜Forming of Protective Layer˜

The protective layer may be formed by preparing the aqueous composition and coating the surface of the metal particle containing layer with the aqueous composition. An order for preparing the aqueous composition for forming the protective layer is not particularly limited, but a method of hydrolyzing the epoxy group-containing alkoxysilane and the epoxy-free alkoxysilane in this order, adding inorganic particles and an aluminum chelate complex in this order to the hydrolyzed solution is preferable, in view solubility and preservation stability.

The coating of the aqueous composition for forming the protective layer may be performed by a well-known method. Examples thereof include a coating method using a spin coater, a roll coater, a bar coater, a curtain coater or the like.

After coating, a step of drying the coating liquid is preferably provided. In the drying step, heat drying is preferably performed. In the heat drying, heating is performed such that the temperature of the coating film is preferably 160° C. or higher, more preferably 170° C. or higher, and even more preferably 180° C. or higher. The temperature of the coating film is preferably 220° C. or less and more preferably 210° C. or less. In a case where the heating and drying temperature is set to be in the above range, the coating film may be sufficiently cured, and also the protective layer may be prevented from being deformed. The heating time is preferably 10 seconds to 5 minutes.

The thickness of the protective layer may be controlled by adjusting the coating amount of the composition for forming the protective layer. In view of the hardness of the obtained protective layer, it is more preferable that the thickness is constant in the range of 0.6 μm to 1.8 μm. In a case where the thickness is 0.6 μm or more, sufficient hardness may be easily exhibited and sufficient functions as the protective layer may be obtained, and also in a case where the thickness is 1.8 μm or less, the internal stress of the protective layer does not become too large, and deformation such as curling is suppressed.

The arithmetic mean surface roughness Ra on the surface of the protective layer may be controlled by the particle diameter and the concentration of solid contents of the contained inorganic particles. In view of the anti-blocking properties of the obtained protective layer, it is preferable that Ra is 1.0 nm to 4.0 nm. In a case where Ra is 1.0 nm or more, sufficient anti-blocking properties are easily exhibited, and the infrared shielding materials may not stick to each other in a case of being overlapped with each other, and the external appearance may be kept satisfactory. Meanwhile, in a case where Ra is 4.0 nm or less, the transparency of the protective layer may be kept satisfactory.

The arithmetic mean surface roughness Ra in the protective layer surface may be measured by using an atomic force microscope (AFM) or the like.

[Layer Configuration of Infrared Shielding Material]

The form of the infrared shielding material is not particularly limited, as long as the infrared shielding material has the above metal particle containing layer. In view of transparency and productivity, the infrared shielding material preferably has an aspect of a film. That is, the infrared shielding material is preferably a thermal insulation film.

Examples of the layer configuration of the infrared shielding material include an aspect in which a support and a metal particle containing layer are laminated in this order.

Other examples thereof include an aspect in which a support, a metal particle containing layer, and a protective layer are laminated in this order.

[Method of Manufacturing Infrared Shielding Material]

The infrared shielding material may be manufactured by forming the above metal particle containing layer. In a case where the infrared shielding material has a support, the infrared shielding material may be manufactured by forming the metal particle containing layer on the support. In a case where the infrared shielding material has a protective layer, the infrared shielding material may be manufactured by forming the protective layer on the metal particle containing layer. The method of forming the respective layers is as described above.

The infrared shielding material may be manufactured by using a roll-like support and may be manufactured by using a sheet-like support. After the respective layers are formed, the infrared shielding material may be wound into a roll shape or may be cut into a sheet shape.

˜Physical Properties of Infrared Shielding Material˜

The infrared shielding material preferably has a maximum value of the reflectances in a wavelength range of 0.78 μm to 1 mm, and more preferably has a maximum value of the reflectances in a wavelength range of 3 μm to 1 mm.

In a case where the metal particle containing layer has the maximum value of the reflectances in the above range, the far-infrared rays may be reflected more efficiently.

The visible light transmittance of the infrared shielding material is preferably 60% or more. In a case where the visible light transmittance is 60% or more, for example, in a case where the infrared shielding material is applied to automotive glass and building glass, external visibility is improved.

The haze of the infrared shielding material of the present invention is preferably 20% or less. In a case where the haze is 20% or less, for example, in a case where the infrared shielding material is applied to automobile glass and building glass, external visibility becomes satisfactory.

The haze was evaluated by the method disclosed in JIS_K_7136.

Specifically, the haze (%) of the infrared shielding material obtained as described above was measured by using a haze meter (NDH-5000, manufactured by Nippon Denshoku Industries Co., Ltd.).

The measurement environment was maintained at a temperature (23±2°)° C. and a relative humidity (50±10)%.

The surface electrical resistance (Ω/square) of the infrared shielding material is preferably 1.0×10⁶ Ω/square or more. The metal particle containing layer having a surface electrical resistance of 1.0×10⁶ Ω/square or more has a high radio wave transmittance since formation of an electric circuit in the layer is suppressed. In view of the above, the surface electrical resistance is more preferably 1.0×10⁸ Ω/square or more, and even more preferably 1.0×10¹² Ω/square or more.

The surface electrical resistance may be measured using a surface electrical resistance measuring device (for example, manufactured by Mitsubishi Chemical Analytech Co., Ltd., LORESTA).

[Application Aspect of Infrared Shielding Material]

The infrared shielding material of the present invention is not particularly limited as long as the aspect is used for selectively reflecting or absorbing far-infrared rays and may be appropriately selected depending on the purpose. Examples thereof include glasses and films for vehicles such as automobiles, glass and films for building materials, and agricultural films. Among these, in view of energy saving effects, glasses and films for vehicles and glasses and films for building materials are preferable.

The glass is not particularly limited and may be appropriately selected depending on the purpose.

Examples of the glass include transparent glasses such as white plate glass, blue plate glass, and CRT blue plate glass.

It is preferable that the surface of the glass support is smooth, and it is particularly preferable that the glass support is float glass.

In order to obtain the visible light transmittance of the glass to which the infrared shielding material is bonded, it is preferable to bond the infrared shielding material to a blue plate glass of 3 mm for measurement. As the blue plate glass of 3 mm, it is preferable to use the glass disclosed in JIS A5759: 2008.

In a case where the infrared shielding material is bonded to the glass, a pressure sensitive adhesive layer may be further formed on the infrared shielding material for bonding. The pressure sensitive adhesive layer may be formed on any surface of the infrared shielding material, but in the case where the infrared shielding material has the support and the metal particle containing layer, it is preferable that the pressure sensitive adhesive layer is formed on the surface of the support.

The material that may be used for forming the pressure sensitive adhesive layer is not particularly limited and may be appropriately selected depending on the purpose. Examples thereof include a polyvinyl butyral (PVB) resin, a (meth)acrylic resin, a styrene/(meth) acryl resin, a urethane resin, a polyester resin, and a silicone resin. Among these, in view of refractive indexes, a (meth)acrylic resin is preferable.

These may be used singly, and two or more kinds thereof may be used in combination.

The pressure sensitive adhesive layer formed from these materials may be formed by coating.

An antistatic agent, a lubricant, an anti-blocking agent, and the like may be added to the pressure sensitive adhesive layer.

The thickness of the pressure sensitive adhesive layer is preferably 0.1 μm to 10 μm.

As the pressure sensitive adhesive layer, a commercially available double-sided tape may be used. Examples of the double-sided tape include PANACLEAN PD-S1 (manufactured by Panac Co., Ltd.).

In a case where the infrared shielding material is applied to the window glass, in view of heat insulating efficiency, the infrared shielding material is preferably attached to the inside of the window, that is, the interior side of the window glass.

In a case where the infrared shielding material is attached to the window glass, a pressure sensitive adhesive layer is provided to the infrared shielding material by coating or lamination, an aqueous solution including a (mainly anionic) surfactant is sprayed on the surface of the glass support and the surface of the pressure sensitive adhesive layer in advance, and the infrared shielding material may be provided on the glass support via the pressure sensitive adhesive layer.

Until the water evaporates, the pressure sensitive adhesive force of the pressure sensitive adhesive layer is low, and the position of the infrared shielding material of the present invention may be adjusted on the surface of the glass support. After the position of attachment of the infrared shielding material to the glass support is determined, the water remaining between the glass support and the infrared shielding material was swept out from the center of the glass toward the end portion by using a squeegee or the like, so as to fix the infrared shielding material on the surface of the glass support. In this manner, an infrared shielding material may be installed on the window glass.

### EXAMPLES

Hereinafter, the present invention will be described more specifically with reference to examples, but the present invention is not limited to the following examples without departing from the gist thereof.

### Example 1

<Manufacturing of Flat Sheet-Like Metal Particle Having Hole>

A polyethylene terephthalate (PET) film (A4300, thickness of 50 μm, manufactured by Toyobo Co., Ltd.) was bonded to a synthetic quartz glass (AQ manufactured by Asahi Glass Co., Ltd.) via a double-sided tape.

The PET film was coated with a resist film for electron beams (FEP-171, manufactured by Fuji Electronics Materials Co., Ltd.).

Drawing patterns in which ring shapes satisfying Condition 1 are randomly arranged on the entire surface of the resist film for electron beams were drawn by electron beams.

—Condition 1—

Shape: Ring shape

Cross-sectional shape: Square

Particle diameter: 500 nm

Particle thickness: 50 nm

Particle line width: 73 nm

Average hole area ratio: 50%

Surface density of flat sheet-like metal particle having hole: 30%

Most adjacent inter-metal particle distance: 0.15 μm

Coefficient of variation: 0%

After a pattern satisfying Condition 1 was drawn, development was performed so as to obtain a resist film in which a concave pattern corresponding to the drawing pattern was formed.

Subsequently, silver (Ag) was deposited by sputtering vapor deposition (manufactured by Shibaura Mechatronics Corporation, CFS-SEP-55) on the surface of the PET film using the resist film in which the pattern is formed as a mask. With respect to the sputtering conditions, sputtering was performed by introducing Ar gas at 15 sccm, setting Varatron vacuum gauge to 0.265 Pa with a VC valve closed, setting RF2 was to 100 W, and setting Ag to 50 nm (target film thickness). The sputtering rate was 1 nm/4.5 s.

Thereafter, the resist film was removed by being dipped in acetone, so as to form flat sheet-like metal particles having holes on the PET film.

Next, various properties of the obtained flat sheet-like metal particles having holes were evaluated as follows.

—Shape—

The surface of the PET film on which the flat sheet-like metal particles having holes obtained above was formed were observed with a scanning electron microscope (SEM) S-4100 (manufactured by Hitachi, Ltd.), and an SEM image (magnification: 10,000 times, acceleration voltage: 7.0 kV) was imaged.

From the obtained SEM image, as illustrated in FIG. 3, it was confirmed that the metal particles were ring-like metal particles.

—Average Hole Area Ratio and Surface Density—

The hole area ratios X of the flat sheet-like metal particle having holes were obtained from radii and hole radii of 200 arbitrarily extracted particles which were measured from the observed SEM image and were obtained by the Formula (1a).

X=π(r2)²/π(r1)²×100 Expression (1a)

In Expression (1a), X represents a hole area ratio, r1 represents a radius of a specific metal particle, and r2 represents a hole radius.

The average hole area ratio X_{AVE} was an arithmetic mean value of the hole area ratios X of 200 particles.

As a result, the average hole area ratio X_{AVE} was 50%.

Next, from the image (FIG. 3) obtained by binarizing the observed SEM image, the surface density Y (unit: %) which was a proportion of a total value of the occupied areas of the flat sheet-like metal particles having holes with respect to the total projected area of the metal particle containing layer in a case of being viewed in a direction perpendicular to the metal particle containing layer was obtained from Formula (2a).

With respect to the SEM image, the surface of the PET film on which the flat sheet-like metal particles having holes were formed was imaged with a scanning electron microscope S-4100 (manufactured by Hitachi, Ltd.) so as to obtain an electron microscopic image (magnification: 10,000 times, acceleration voltage: 7.0 kV).

Y=π(radius of specific metal particle)×the number of specific metal particles per unit area Expression (2a)

As a result, the surface density of the flat sheet-like metal particles having holes was 30%.

—Proportion of Circular Particles, Average Particle Diameter (Average Maximum Length), and Coefficient of Variation—

With respect to the shape uniformity of the flat sheet-like metal particles having holes, image analysis was performed on the shapes of 200 particles arbitrarily extracted from the observed SEM image with circular particles as A and particles other than A as B, so as to obtain the proportion (% by number) of the number of particles corresponding to A. As a result, the circular particles were 100%.

Similarly, the particle diameter of 100 particles corresponding to the above A was measured from the SEM image, and the average value was taken as the average particle diameter (average maximum length), and the standard deviation of the particle diameter in the particle diameter distribution was divided by the average particle diameter (average maximum length), so as to obtain the coefficient of variation (%). As a result, the average particle diameter was 500 nm, and the coefficient of variation was 0%.

With respect to the SEM image, the surface of the PET film on which the flat sheet-like metal particle having holes were formed was imaged with a scanning electron microscope S-4100 (manufactured by Hitachi, Ltd., magnification: 10,000 times, acceleration transmission 7.0 kV). Various evaluations from the captured SEM image were performed by using image processing software ImageJ.

—Particle Thickness, Cross-Sectional Shape, Particle Line Width, and Aspect Ratio of Cross Section of Particles—

The thickness of one flat sheet-like metal particles having a hole on the PET film on which the flat sheet-like metal particles having holes were formed was measured by using an atomic force microscope (AFM) (Nanocute II, manufactured by Seiko Instruments Inc.) The measurement conditions of the AFM were a self-detecting type sensor, a DFM mode, a measurement range of 5 μm, a scanning speed of 180 seconds/1 frame, and a data point number of 256×256.

In measurement the thickness, the shape of the cross section of the flat sheet-like metal particles having holes is also observed in order to detect the displacement in the direction perpendicular to the PET film with respect to the flat sheet-like metal particles having holes on the PET film is also observed.

The particle line width was obtained from the particle diameter and the hole diameters of 200 arbitrarily extracted particles measured from the SEM image observed above by the following expression.

Particle line width=(Particle diameter−hole diameter)/2

The aspect ratio of the cross section of the particle was calculated by dividing the particle line width by the particle thickness.

As a result of these evaluations, the particle thickness was 50 nm, the cross-sectional shape was square, the particle line width was 73 nm, and the aspect ratio was 1.46.

—Most Adjacent Inter-Metal Particle Distance—

An SEM image of the PET film on which the flat sheet-like metal particles having holes were formed was taken into ImageJ which is analysis software, and the most adjacent metal particle center-to-center distance was measured. After binarizing the SEM image, the outline of the metal particle was detected, and it was assumed that the thickness of the metal particle was even, so as to obtain the barycentric coordinates of the metal particles. The distances between the barycentric coordinates of all the metal particles were obtained, and the minimum distance between the barycentric coordinates was obtained as the most adjacent metal particle center-to-center distance.

Here, the most adjacent inter-metal particle distance was regulated by the following expression.

Most adjacent inter-metal particle distance (μm)=most adjacent metal particle center-to-center distance (μm)−particle diameter (μm)

From the above expression, the most adjacent inter-metal particle distance was 0.15 μm.

In the above expression, the particle diameter (μm) was an average of the particle diameters of two particles set as most adjacent metal particles.

—Plane Alignment of Particle—

The PET film on which the flat sheet-like metal particles having holes were formed was cut in a direction perpendicular to the surface of the PET film to manufacture a cross section observation sample. This cross section observation sample was imaged by a scanning electron microscope (manufactured by Hitachi, Ltd.) to obtain an electron microscopic image (magnification: 60,000 times, acceleration transmission: 7.0 kV), and inclination angles of 50 flat sheet-like metal particles having holes with respect to the horizontal plane of the PET film were calculated as an average value.

As a result, the plane alignment of the particles was 0°.

From each of the above evaluations, it was confirmed that the obtained particles were flat sheet-like metal particles having the holes of Condition 1.

<Manufacturing of Infrared Shielding Material>

A PET film on which flat sheet-like metal particles having holes were formed was coated with a mixed solution of 1 mass % of polyvinyl butyral (PVB) (manufactured by Wako Pure Chemical Industries, Ltd., average degree of polymerization: 700) as a binder and a mixed solvent (toluene:acetone=1:1 (mass ratio)) of toluene-acetone by using a wire application bar and dried, so as to form a metal particle containing layer including flat sheet-like metal particles having holes such that the average thickness after drying became 1 μm.

Thereafter, the PET film was peeled off from the synthetic quartz substrate to obtain an infrared shielding material.

—Measuring Transmittance and Reflectance of Visible Range—

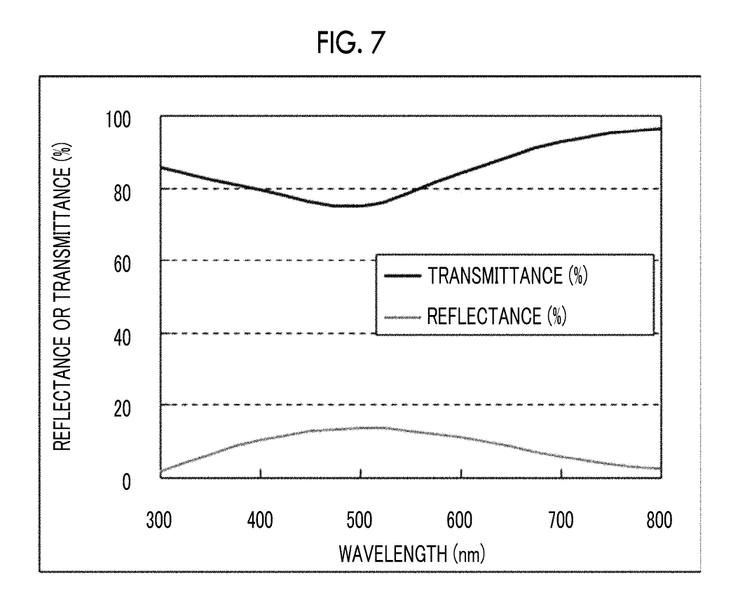

The reflection spectrum and the transmission spectrum of the manufactured infrared shielding material were measured in the wavelength range of 300 nm to 800 nm by using an ultraviolet-visible near-infrared spectrometer (manufactured by JASCO Corporation, V-670). For reflection spectrum measurement and transmission spectrum measurement, an integrating sphere unit (ARV-474, manufactured by JASCO Corporation) was used, and incidence rays were set as incidence rays that may be regarded as unpolarized light through a 45° polarizing plate. A graph presenting the measurement results is illustrated in FIG. 7.

In FIG. 7, it is understood that the transmittance of the manufactured infrared shielding material at a wavelength of 300 nm to 800 nm was 70% or more, and the transparency was excellent.

—Measuring Reflection of Far-Infrared Range—

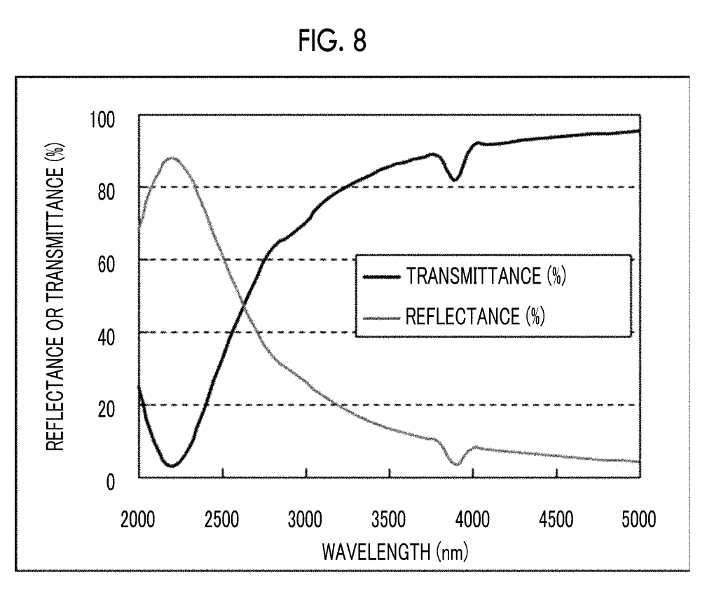

The reflection spectrum and the transmission spectrum of the manufactured infrared shielding materials were measured in the wavelength range of 2,000 nm to 5,000 nm by using an infrared spectrometer IFS 66 v/S (manufactured by Bruker Optics). A graph of measurement results is illustrated in FIG. 8.

In FIG. 8, it is understood that the reflectance of the manufactured infrared shielding material at a wavelength of 3,000 nm was about 25%, and the reflectance of far-infrared rays was high.

—Radio Wave Transmitting Properties—

Surface electrical resistance (Ω/square) of the manufactured infrared shielding material was measured by using a surface electrical resistance measuring device (manufactured by Mitsubishi Chemical Analytech Co., Ltd., LORESTA) and was used as an indicator of radio wave transmitting properties. As the surface electrical resistance of the infrared shielding material is higher, electricity in the material becomes more difficult to flow, and the amount of radio waves absorbed by the material in a case where the radio waves pass through the material may be suppressed. That is, as the surface electrical resistance is higher, the radio wave transmitting properties becomes more excellent.

The surface electrical resistance of the manufactured infrared shielding material was 9.9×10¹² Ω/square and was excellent in the radio wave transmitting properties.

### Example 2

An infrared shielding material was manufactured in the same manner as in Example 1, except that Condition 1 was changed to Condition 2, and various evaluations were performed.

—Condition 2—

Shape: Ring shape

Cross-sectional shape: Square

Particle diameter: 500 nm

Particle thickness: 50 nm

Particle line width: 40 nm

Average hole area ratio: 70%

Surface density of flat sheet-like metal particle having hole: 50%

Most adjacent inter-metal particle distance: 0.1 μm

Coefficient of variation: 0%

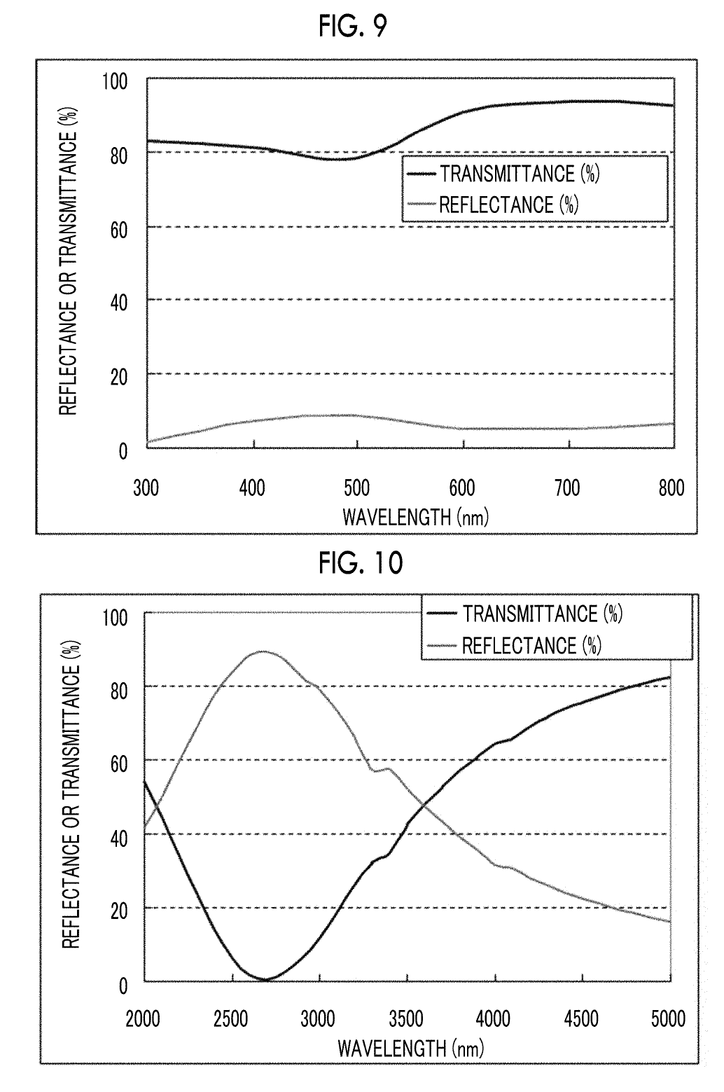

The transmittance and the reflectance of the manufactured infrared shielding material of Example 2 at a wavelength of 300 nm to 800 nm were illustrated in FIG. 9.

In FIG. 9, it is understood that the transmittance of the manufactured infrared shielding material of Example 2 at a wavelength of 300 nm to 800 nm was about 80% or more, and the transparency was excellent.

The transmittance and the reflectance of the manufactured infrared shielding material of Example 2 at a wavelength of 2,000 nm to 5,000 nm were illustrated in FIG. 10.

In FIG. 10, it is understood that the reflectance of the manufactured infrared shielding material of Example 2 in a wavelength range of 3,000 nm to 4,000 nm was 30% or more, and the reflectance of far-infrared rays was high.

With respect to the infrared shielding material of Example 2, the surface electrical resistance was measured in the same manner as in Example 1, and as a result, the surface electrical resistance value was 9.9×10¹² (Ω/square), and it was indicated that the radio wave transmitting properties were excellent.

It is possible to obtain flat sheet-like metal particles having holes of which the reflectances and the transmittances of light in the far-infrared range and the visible range were changed by changing the particle shape, the particle diameter, the particle thickness, and the particle line width in the flat sheet-like metal particles having the holes, and the surface density, the most adjacent inter-metal particle distance, and the numerical values of the coefficient of variation of the flat sheet-like metal particle having holes.

The reflection spectra and the transmission spectra of light in the far-infrared range and the visible range in the metal particle containing layer containing the flat sheet-like metal particles having holes may be obtained by simulation below.

### Example 3

<Manufacturing of Flat Sheet-Like Metal Particle Having Hole>

Synthetic quartz glass (manufactured by Asahi Glass Co., Ltd., AQ) was coated with a resist film for electron beams (manufactured by Fuji Electronics Materials Co., Ltd., FEP-171).

Drawing patterns in which squares satisfying Condition 3 are periodically arranged on the entire surface of the resist film for electron beams were drawn by electron beams.

—Condition 3—

Shape: Square

Cross-sectional shape: Square

Particle diameter (one side): 1,000 nm

Particle thickness: 50 nm

Particle line width: 150 nm

Average hole area ratio: 50%

Surface density of flat sheet-like metal particle having hole: 25%

Most adjacent inter-metal particle distance: 1.0 μm

Coefficient of variation: 0%

After a pattern satisfying Condition 3 was drawn, development was performed so as to obtain a resist film in which a concave pattern corresponding to the drawing pattern was formed.

Next, sputtering vapor deposition (manufactured by Shibaura Mechatronics Corporation, CFS-SEP-55) was performed on a glass surface by using the resist film in which a concave pattern was formed was used as a mask, such that the thickness of germanium (Ge) became 10 nm, and the thickness of the Ag alloy became 40 nm.

Thereafter, the resist film was removed by being dipped in acetone, so as to form flat sheet-like metal particles having holes on a glass substrate.

Next, various properties of the obtained flat sheet-like metal particles having holes were evaluated as follows.

—Shape—

The surface of the glass substrate on which the flat sheet-like metal particles having holes obtained above were formed was imaged with a scanning electron microscope (SEM) S-4100 (manufactured by Hitachi, Ltd.), and an SEM image (magnification: 10,000 times, acceleration voltage: 7.0 kV).

From the obtained SEM image, as illustrated in FIG. 17, it was confirmed that the metal particles were square-like metal particles.

—Average Hole Area Ratio and Surface Density—

In the same method as in Example 1, the average hole area ratio X_{AVE} calculated based on the hole area ratio X obtained from Formula (1a) was 50%.

Next, the surface density of the flat sheet-like metal particles having holes obtained from Formula (2a) based on an image (FIG. 17) obtained by binarizing the observed SEM image in the same method as in Example 1 was 30%.

—Proportion of Circular Particles, Average Particle Diameter (Average Maximum Length), and Coefficient of Variation—

With respect to the shape uniformity of the flat sheet-like metal particles having holes, image analysis was performed on the shapes of 200 particles arbitrarily extracted from the observed SEM image with square particles as A and particles other than A as B, so as to obtain the proportion (% by number) of the number of particles corresponding to A. As a result, the square particles were 100%.

Similarly, the particle diameter of 100 particles corresponding to the above A was measured from the SEM image, and the average value was taken as the average particle diameter (average maximum length), and the standard deviation of the particle diameter in the particle diameter distribution was divided by the average particle diameter (average maximum length), so as to obtain the coefficient of variation (%). As a result, the average particle diameter was 1,000 nm, and the coefficient of variation was 0%. Here, in the present example, the particle diameter of one side of the square was defined as the particle diameter of the square particle.

With respect to the SEM image, the surface of the glass substrate on which the flat sheet-like metal particle having holes were formed was imaged with a scanning electron microscope S-4100 (manufactured by Hitachi, Ltd., magnification: 10,000 times, acceleration transmission 7.0 kV). Various evaluations from the captured SEM image were performed by using image processing software ImageJ.

—Particle Thickness, Cross-Sectional Shape, Particle Line Width, and Aspect Ratio of Cross Section of Particles—

Example 1 was evaluated except that a polyethylene terephthalate (PET) film in which flat sheet-like metal particles having hole were formed was replaced by the glass substrate on which the flat sheet-like metal particles having hole were formed in the same manner as in Example 1, and as a result, the particle thickness was 50 nm, the cross-sectional shape was square, the particle line width was 150 nm, and the aspect ratio was 3.

—Most Adjacent Inter-Metal Particle Distance—

The most adjacent inter-metal particle distance obtained by the same method as in Example 1 was 1.0 μm.

—Plane Alignment of Particle—

Since the flat sheet-like metal particle having holes were formed on the glass substrate, the plane alignment of the particles was set to 0°.

From each of the above evaluations, it was confirmed that the obtained particles were flat sheet-like metal particles having the holes of Condition 3.

<Manufacturing of Infrared Shielding Material>

A glass substrate in which the flat sheet-like metal particles having holes were formed was used as an infrared shielding material.

—Measuring Transmittance and Reflectance of Visible Range—

The transmittance and reflectance of the visible range were measured by the same method as in Example 1.

The transmittance of the manufactured infrared shielding material at a wavelength of 300 nm to 800 nm was 70% or more, and the transparency was excellent.

—Measuring Reflection of Far-Infrared Range—

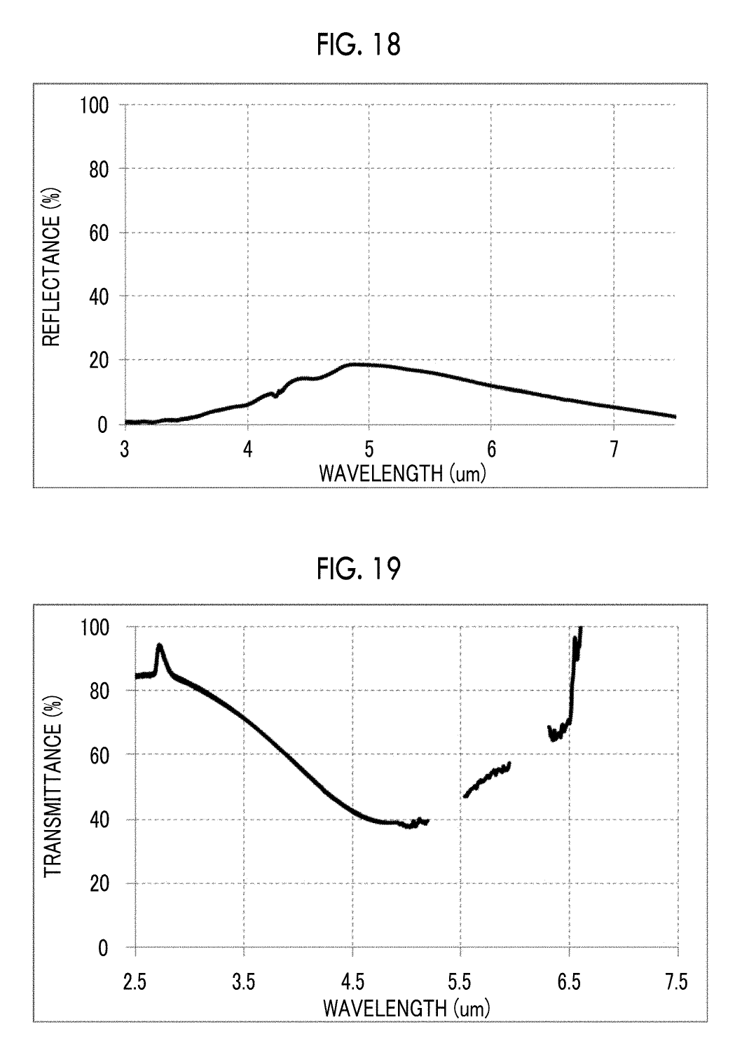

The reflection spectrum of the manufactured infrared shielding material was measured in the wavelength range of 2,500 nm to 7,000 nm using an infrared spectrometer FTS-7000 (manufactured by Varian). Further, the transmission spectrum was measured in the wavelength range of 2,500 nm to 7,000 nm by using an infrared spectrometer NICOLET 4700 (manufactured by Thermo Fisher Scientific). Graphs of the measurement results excluding the influence of the glass of the substrate are presented in FIGS. 18 and 19, respectively.

In FIGS. 18 and 19, it is understood that the reflectance of the manufactured infrared shielding material at a wavelength of 5,000 nm was about 20%, and the reflectance of far-infrared rays became high.

—Radio Wave Transmitting Properties—

Surface electrical resistance (Ω/square) was measured by the same method as in Example 1, and was used as an indicator of radio wave transmitting properties.

The surface electrical resistance of the manufactured infrared shielding material was 9.9×10¹² Ω/square and was excellent in the radio wave transmitting properties.

### Example 4

—Condition Setting—

First of all, it was assumed that flat sheet-like metal particles having no hole and flat sheet-like metal particles having holes were Particles C and Particles R1, and various numerical values were set as follows.

Particle C (Circle)

Shape: Circular shape

Cross-sectional shape: Square

Particle diameter: 850 nm

Particle thickness: 50 nm

Particle line width: No value

Hole area ratio: No value

Surface density of flat sheet-like metal particle having hole: 40%

Most adjacent inter-metal particle distance: 0.11 μm

Coefficient of variation: 0%

Particle R1 (Ring)

Shape: Ring shape

Cross-sectional shape: Square

Particle diameter: 500 nm

Particle thickness: 50 nm

Particle line width: 56 nm

Hole area ratio: 60%

Surface density of flat sheet-like metal particle having hole: 40%

Most adjacent inter-metal particle distance: 0.15 μm

Coefficient of variation: 0%

—Modeling Metal Particle Single Layer Arrangement—

As parameters to be used for creating a simulation model, shapes, cross-sectional shapes, particle diameters, particle thicknesses, particle line widths, and hole area ratios of Particles C and Particles R1, surface density of the flat sheet-like metal particles having holes, most adjacent inter-metal particle distances, and coefficient of variation were input. The diameter of the circumscribed circle of the flat sheet-like metal particles having the holes was defined as the particle diameter. The hole area ratio X and the average hole area ratio X_{AVE} were the same values in the simulation.

The positions in the horizontal planes of the metal particles are randomly arranged so as to satisfy the condition that other metal particles are not present in a distance less than the most adjacent inter-metal particle distance.

Specifically, in a case where an n-th particle is arranged, in a case where the particle is arranged in a specific coordinate determined by a random number generated by a calculator, distances to the entire 1 to (n−1)-th metal particles are measured, and the distances to the entire metal particles are the most adjacent inter-metal particle distance or more, which satisfy the condition, the n-th particle is arranged at the position. In a case where any one flat sheet-like metal particle having a hole is present in a distance of less than the most adjacent inter-metal particle distance, the position is discarded, and the arrangement position is determined such that a flat sheet-like metal particle having an n-th hole in another coordinate newly generated is present.

An algorithm for repeating the determination of the above arrangement position is executed with respect to the flat sheet-like metal particles having all the holes, and the metal particles are arranged until the area ratio of Particles C or Particles R1 was satisfied so as to obtain a model of flat sheet-like metal particles having holes in a random structure.

In a case where a random structure in which the particles do not contact each other as described above is employed, an electric circuit is not formed in the metal particle containing layer, and the infrared shielding material may maintain high surface electrical resistance. That is, it was assumed that the model has excellent radio wave transmitting properties.

For the thickness direction of the metal particle containing layer, a simulation model is created under the condition that the metal particles are present at the same height as a single layer.

—Simulation by FDTD Method—

With respect to the random arrangement structure of the metal particle of the simulation model created above, spectral (transmission, reflection, and absorption) spectra in the visible range and the far-infrared range were calculated by an electromagnetic field optical simulation FDTD (finite-difference time-domain) method.

As the input parameters to the model, the spectral characteristics of the complex refractive index of the flat sheet-like metal particle having holes and the surrounding medium were input.

For complex refractive indexes of metal particles, for example, for silver (Ag), fitting was performed on the complex refractive index disclosed in P. B. Johnson and R. W. Christy, Optical Constants of the Noble Metals, Phys. Rev. B6, 4370 to 4379 (1972) by Drude model, and the values of the complex refractive index calculated in a wavelength of 300 nm to 50 μm at intervals of 5 nm were used.

The surrounding medium was set to n=1.50, and k=0.00.

The calculation of the spectral spectrum was performed by the FDTD method in the range required for the optical characteristics in the wavelength range of the wavelength of 300 nm to 50 μm. From this spectral spectrum, the transmittance of the visible range and the maximum reflectance in the infrared range were obtained. The peak wavelength of the reflectance was set to the wavelength exhibiting the largest reflectance among the reflectances of all the wavelengths.

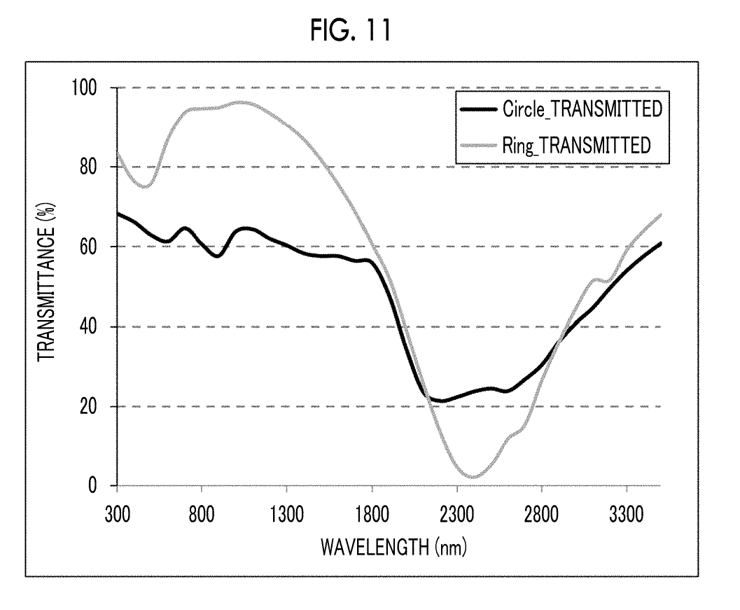

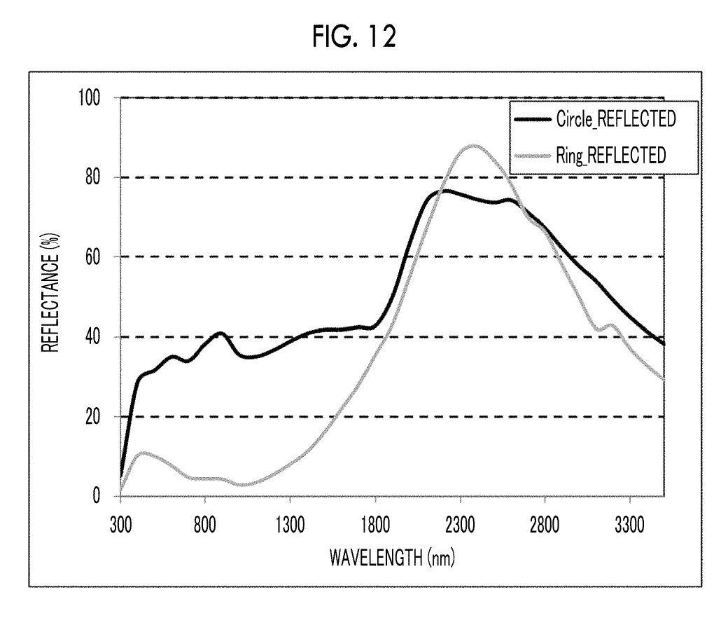

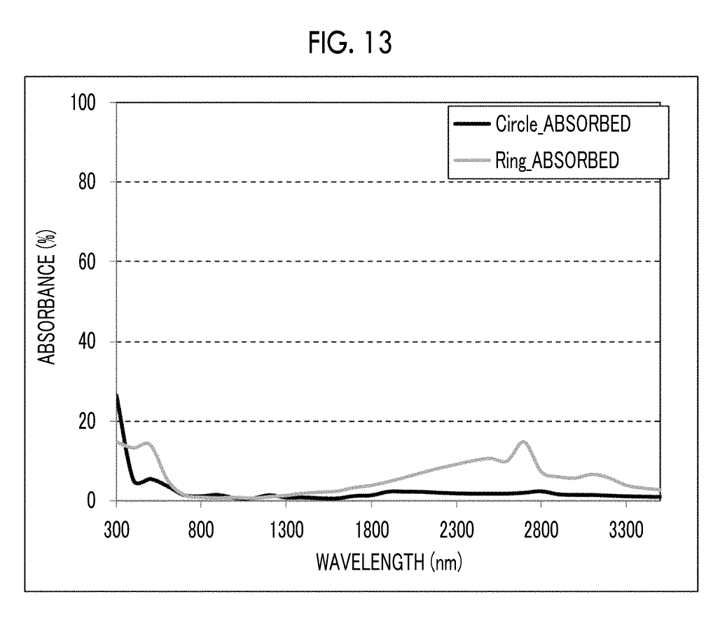

The reflection spectra and the transmission spectra of the flat sheet-like metal particles (Particle C: comparative example) having no hole and the flat sheet-like metal particles having holes (Particles R1: the present invention) at a wavelength of 300 nm to 3,500 nm were obtained by using the above simulation, so as to compare Particles C and Particles R1. Reflection spectra, transmission spectra, and absorption spectra of Particles C and Particles R1 at a wavelengths of 300 nm to 3,500 nm are illustrated in FIGS. 11 to 13.

Particles C and Particles R1 were selected such that resonance wavelengths were substantially the same, and the areal densities of the flat sheet-like metal particles having holes became identical to each other.

In FIGS. 11 to 13, in a case where the reflection spectra, the transmission spectra, and the absorption spectra of Particles C which was a circular metal particle and Particles R1 which was a ring-like metal particle were compared with each other, it is understood that, the flat sheet-like metal particles had holes, and thus it is able to obtain a higher transmittance and a lower reflectance in the visible range.

It is understood that Particles C and Particles R1 had the same resonance wavelength and high reflection performance at the resonance wavelength of Particles R1. On the other hand, in the visible range, it is understood that Particles R1 exhibited a higher transmittance than the Particles C.

It is understood that Particles R1 had higher absorption in the wavelength range of 1,800 to 3,300 nm compared with Particles C.

From the above results, in a case where the optical characteristics of the flat sheet-like metal particles having the same resonance wavelength and the flat sheet-like metal particles having the holes were compared with each other, it is understood that the latter was able to resonate with small particles and had holes so as to have a larger region for transmission of light, and thus the transmittance increases.

The change of the optical characteristics of the flat sheet-like metal particles having holes depending on the hole area ratio X (%) and surface density Y (%) was calculated by an electromagnetic field optical simulation FDTD method.

The evaluated optical characteristics are the maximum reflectance in the infrared range (Table 1), the average transmittance of the visible range (Table 2), and the wavelength exhibiting the maximum reflection in the infrared range (peak wavelength) (Table 3), respectively, and are presented in Tables 1 to 3.

The average transmittance of the visible range was obtained as below.

Transmittances at a wavelength of 350 nm to 800 nm were calculated by increments of 50 nm by the FDTD method, and the average value thereof was taken as the average transmittance.

The particle shape of the flat sheet-like metal particles having holes used for the calculation is as follows.

Particles R2

Shape: Ring shape

Cross-sectional shape: Square

Particle diameter: 500 nm

Particle thickness: 50 nm

Particle line width: T nm

Hole area ratio: X %

Surface density of flat sheet-like metal particle having hole: Y %

Most adjacent inter-metal particle distance: 0.15 μm

Coefficient of variation: 0%

The most adjacent inter-particle distance of Particles R2 was set such that the metal particles were not in contact with each other and uniformly arranged. The particle line width T (nm) and the hole area ratio X (%) are expressed by the following relation expression.

Particle line width T (nm)=Particle radius (nm)×SQRT(hole area ratio X (%)/100)

SQRT represents a value in the parentheses after SQRT is a square root.

The surrounding medium was set to n=1.50, and k=0.00.

TABLE 1

| | | Hole area ratio X (%) | | | | | | | | | | |
|---|---|---|---|---|---|---|---|---|---|---|---|---|
| | | 0 | 10 | 20 | 30 | 40 | 50 | 60 | 70 | 80 | 90 | 100 |
| Surface | 0 | — | — | — | — | — | — | — | — | — | — | — |
| density Y | 10 | 52.0 | 51.0 | 46.7 | 48.8 | 48.3 | 45.4 | 43.9 | 44.7 | 39.8 | 24.1 | — |
| (%) | 20 | 63.3 | 63.1 | 65.5 | 74.1 | 75.9 | 80.4 | 80.4 | 74.3 | 66.1 | 43.6 | — |
| | 30 | 77.0 | 78.2 | 82.4 | 85.1 | 86.9 | 87.9 | 86.3 | 82.1 | 73.5 | 57.7 | — |
| | 40 | 84.8 | 85.5 | 86.7 | 88.8 | 91.0 | 90.2 | 87.8 | 84.3 | 78.8 | 60.0 | — |
| | 50 | 93.9 | 92.9 | 92.5 | 93.6 | 94.3 | 92.8 | 91.8 | 89.0 | 83.5 | 68.5 | — |
| | 60 | 91.9 | 93.5 | 94.4 | 95.5 | 94.7 | 93.2 | 92.9 | 90.2 | 87.3 | 70.7 | — |
| | 70 | 94.7 | 93.6 | 96.7 | 96.1 | 95.3 | 93.2 | 91.9 | 90.2 | 87.3 | — | — |
| | 80 | 97.5 | 97.7 | 97.8 | 97.6 | 96.9 | 93.5 | 93.7 | 93.9 | 89.4 | — | — |
| | 90 | — | — | — | — | — | — | — | — | — | — | — |
| | 100 | — | — | — | — | — | — | — | — | — | — | — |

TABLE 2

| | | Hole area ratio X (%) | | | | | | | | | | |
|---|---|---|---|---|---|---|---|---|---|---|---|---|
| | | 0 | 10 | 20 | 30 | 40 | 50 | 60 | 70 | 80 | 90 | 100 |
| Surface | 0 | — | — | — | — | — | — | — | — | — | — | — |
| density Y | 10 | 90.5 | 91.4 | 91.8 | 92.9 | 94.0 | 95.2 | 96.4 | 97.5 | 98.5 | 99.3 | — |
| (%) | 20 | 80.9 | 82.8 | 83.5 | 85.5 | 87.7 | 90.0 | 92.5 | 94.8 | 96.8 | 98.5 | — |
| | 30 | 71.5 | 74.1 | 75.3 | 78.1 | 81.5 | 85.1 | 88.7 | 92.2 | 95.3 | 97.7 | — |
| | 40 | 62.6 | 65.6 | 67.2 | 70.9 | 75.1 | 80.0 | 84.8 | 89.4 | 93.4 | 96.8 | — |
| | 50 | 54.0 | 56.8 | 59.0 | 63.5 | 68.7 | 74.4 | 90.2 | 86.2 | 91.5 | 95.8 | — |
| | 60 | 38.5 | 41.8 | 43.4 | 49.1 | 56.1 | 64.3 | 71.7 | 81.0 | 88.6 | 94.6 | — |
| | 70 | 25.1 | 30.5 | 31.8 | 39.1 | 47.9 | 57.5 | 67.2 | 76.9 | 86.7 | 93.6 | — |
| | 80 | 15.2 | 26.7 | 30.4 | 38.0 | 46.5 | 56.0 | 66.6 | 65.9 | 85.5 | 93.1 | — |
| | 90 | — | — | — | — | — | — | — | — | — | — | — |
| | 100 | — | — | — | — | — | — | — | — | — | — | — |

TABLE 3

| | | Hole area ratio X (%) | | | | | | | | | | |
|---|---|---|---|---|---|---|---|---|---|---|---|---|
| | | 0 | 10 | 20 | 30 | 40 | 50 | 60 | 70 | 80 | 90 | 100 |
| Surface | 0 | — | — | — | — | — | — | — | — | — | — | — |
| density Y | 10 | 2000 | 2000 | 2100 | 2100 | 2200 | 2300 | 2500 | 2800 | 3200 | 4000 | — |
| (%) | 20 | 1800 | 1800 | 2000 | 2000 | 2100 | 2200 | 2400 | 2600 | 3000 | 3800 | — |
| | 30 | 1500 | 1700 | 1800 | 1900 | 2000 | 2200 | 2400 | 2600 | 3000 | 4000 | — |
| | 40 | 1500 | 1500 | 1600 | 1900 | 2000 | 2200 | 2400 | 2600 | 3100 | 4100 | — |
| | 50 | 1200 | 1300 | 1600 | 1800 | 2000 | 2100 | 2400 | 2700 | 3100 | 4100 | — |
| | 60 | 1300 | 1300 | 1700 | 1800 | 2100 | 2200 | 2600 | 2800 | 3200 | 4300 | — |
| | 70 | 1100 | 1300 | 1700 | 1800 | 2100 | 2300 | 2900 | 3400 | 3700 | 5000 | — |
| | 80 | 1500 | 1500 | 1900 | 2200 | 2500 | 3400 | 3600 | 3600 | 4600 | — | — |
| | 90 | — | — | — | — | — | — | — | — | — | — | — |
| | 100 | — | — | — | — | — | — | — | — | — | — | — |

The change of the optical characteristics of the flat sheet-like metal particles having holes depending on the coefficient of variation Z (%) was calculated by an electromagnetic field optical simulation FDTD method.

The evaluated optical characteristics are the maximum reflectance in the infrared range, the wavelength (peak wavelength) exhibiting the maximum reflection in the infrared range, and the bandwidth of the reflection characteristic.

Here, the bandwidth of the reflection characteristic is defined as follows. The transmittances at a wavelength of 300 nm to 8,000 nm were calculated by increments of 100 nm by the FDTD method and the peak value of the reflectance was taken as the maximum reflectance in the infrared range. The maximum wavelength range below this value of ½ of the maximum reflectance was selected as the bandwidth.

The conditions of the flat sheet-like metal particles having holes used for calculation are as follows.

Particle R3

Shape: Ring shape

Cross-sectional shape: Square

Particle diameter: 500 nm

Particle thickness: 50 nm

Particle line width: 50 nm

Hole area ratio: 64%

Surface density of flat sheet-like metal particle having hole: 40%

Most adjacent metal inter-metal particle distance: 0.11 μm

Coefficient of variation: 15%

Particles R4

Shape: Ring shape

Cross-sectional shape: Square

Particle diameter: 500 nm

Particle thickness: 50 nm

Particle line width: 50 nm

Hole area ratio: 64%

Surface density of flat sheet-like metal particle having hole: 30%

Most adjacent inter-metal particle distance: 0.11 μm

Coefficient of variation: 30%

Particle R5

Shape: Ring shape

Cross-sectional shape: Square

Particle diameter: 500 nm

Particle thickness: 50 nm

Particle line width: 50 nm

Hole area ratio: 64%

Surface density of flat sheet-like metal particle having hole: 40%

Most adjacent metal inter-metal particle distance: 0.11 μm

Coefficient of variation: 40%

The most adjacent inter-particle distances of Particles R3 to R5 were set such that the metal particles were not in contact with each other and uniformly arranged.

The surrounding medium was set to n=1.50, and k=0.00.

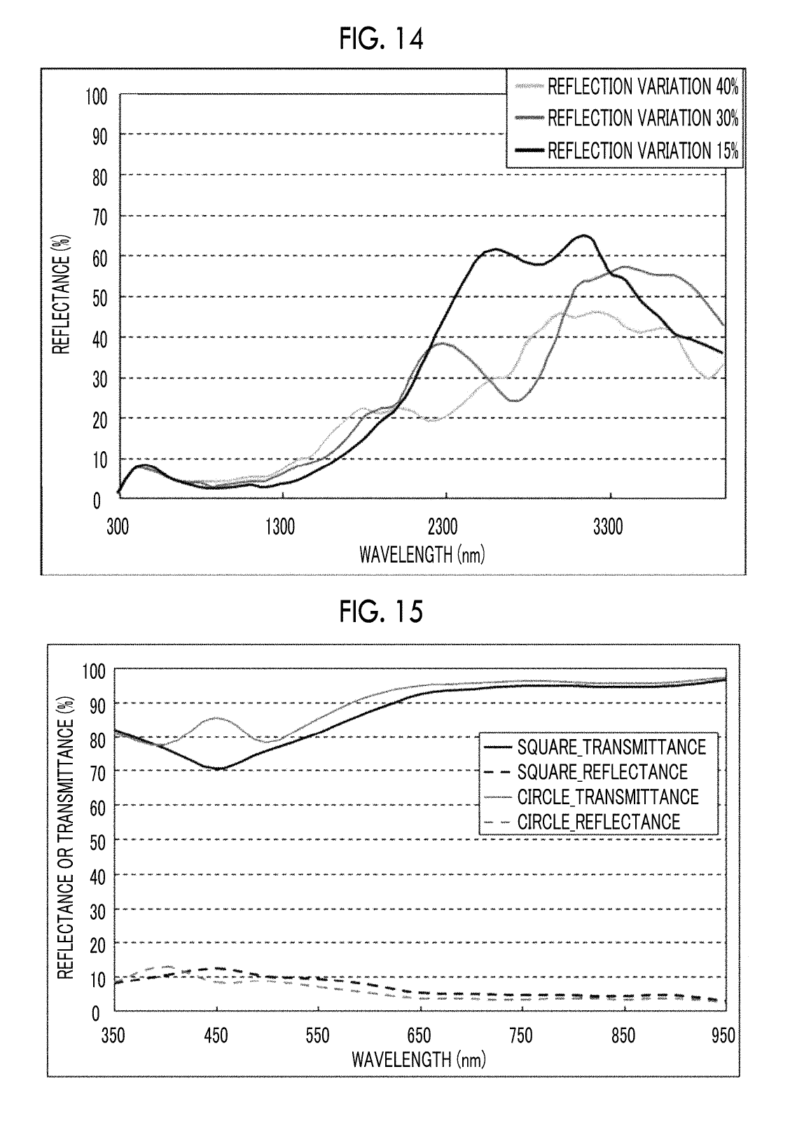

The calculation results of the wavelength range of 300 nm to 4,000 nm are illustrated in FIG. 14. The coefficient of variation, the maximum reflectance, the peak wavelength, and the peak bandwidth of Particles R3 to R5 were as presented in Table 4 below.

TABLE 4

| | Coefficient of | Maximum | Peak wavelength | Bandwidth |
|---|---|---|---|---|
| Particle | variation (%) | reflectance (%) | (nm) | (nm) |
| R3 | 15 | 64.4 | 3100 | 1900 |
| R4 | 30 | 57.4 | 3400 | 2200 |
| R5 | 40 | 45.7 | 3200 | 2300 |

In FIG. 14 and Table 4, in a case where R3 (coefficient of variation: 15%), R4 (coefficient of variation: 30%), and R5 (coefficient of variation: 40%) were compared with each other, as the coefficient of variation increases, it was understood that the reflectance (maximum reflectance) in the peak wavelength decreases, and thus the bandwidth of the peak becomes wider.

From this, it was understood that, as the coefficient of variation in the infrared shielding material was lower, the reflectance of the desired wavelength was able to be increased, and thus it was possible to efficiently reflect the far-infrared rays.

The change of the optical characteristics of the flat sheet-like metal particles having holes depending on the cross-sectional shape of the particle was calculated by an electromagnetic field optical simulation FDTD method.

The evaluated sectional shape was a square and a circular shape. The evaluated optical characteristics were an average transmittance of the visible range.

Here, the average transmittance of the visible range is obtained as below. Transmittances at a wavelength of 350 nm to 950 nm were calculated by increments of 50 nm by the FDTD method, and the average value at a wavelength of 350 nm to 800 nm was taken as the average transmittance.

The conditions of the flat sheet-like metal particles having holes used for calculation are as follows.

Particle R6

Shape: Ring shape

Cross-sectional shape: Square

Particle diameter: 500 nm

Particle thickness: 50 nm

Particle line width: 56 nm

Hole area ratio: 60%

Surface density of flat sheet-like metal particle having hole: 40%

Most adjacent metal inter-metal particle distance: 0.07 μm

Coefficient of variation: 0%

Particle R7

Shape: Ring shape

Cross-sectional shape: Circular shape

Particle diameter: 500 nm

Particle thickness: 50 nm

Particle line width: 56 nm

Hole area ratio: 60%

Surface density of flat sheet-like metal particle having hole: 40%

Most adjacent inter-metal particle distance: 0.07 μm

Coefficient of variation: 0%

The most adjacent inter-particle distances of Particles R6 and R7 were set such that the metal particles were not in contact with each other and uniformly arranged. The particle line width was obtained from the hole area ratio X (%) as follows.

Particle line width (nm)=Particle radius (nm)×SQRT(hole area ratio X (%)/100)

The surrounding medium was set to n=1.50, and k=0.00.

Calculation results thereof are presented in FIG. 15. The average transmittance of the visible range of Particles R6 and R7 was as presented in Table 5.

TABLE 5

| | | Average transmittance of |
|---|---|---|
| Particle | Cross-sectional shape | visible range (%) |
| R6 | Square | 84.8 |
| R7 | Circular shape | 88.1 |

In FIG. 15 and Table 5, it is understood that, in a case where the cross-sectional shape is a circular shape, the average transmittance of the visible range was high. It is assumed that this is because, in a case where the cross-sectional shape is a square, the influence of plasmon resonance occurring in the cross section range with respect to the incidence rays is reduced due to the circular cross-sectional shape.

The change of the optical characteristics of the flat sheet-like metal particles having holes depending on the aspect ratio of the cross section of the particles was calculated by an electromagnetic field optical simulation FDTD method. The aspect ratio of the cross section was obtained as follows.

Aspect ratio=particle line width/particle thickness

Transmittances at a wavelength of 350 nm to 950 nm were calculated by increments of 50 nm by the FDTD method, and the average value at a wavelength of 350 nm to 800 nm was taken as the average transmittance of the visible range.

The conditions of the flat sheet-like metal particles having holes used for calculation are as follows.

Particle R8

Shape: Ring shape

Cross-sectional shape: Square

Particle diameter: 500 nm

Particle thickness: 50 nm

Particle line width: 50 nm

Aspect ratio: 1

Hole area ratio: 64%

Surface density of flat sheet-like metal particle having hole: 40%

Most adjacent metal inter-metal particle distance: 0.1 μm

Coefficient of variation: 0%

Particle R9

Shape: Ring shape

Cross-sectional shape: Square

Particle diameter: 500 nm

Particle thickness: 50 nm

Particle line width: 75 nm

Aspect ratio: 1.5

Hole area ratio: 49%

Surface density of flat sheet-like metal particle having hole: 40%

Most adjacent inter-metal particle distance: 0.1 μm

Coefficient of variation: 0%

Particle R10

Shape: Ring shape

Cross-sectional shape: Square

Particle diameter: 500 nm

Particle thickness: 50 nm

Particle line width: 100 nm

Aspect ratio: 2

Hole area ratio: 36%

Surface density of flat sheet-like metal particle having hole: 40%

Most adjacent inter-metal particle distance: 0.1 μm

Coefficient of variation: 0%

The most adjacent inter-particle distances of Particles R8 to R10 were set such that the metal particles were not in contact with each other and uniformly arranged.

The surrounding medium was set to n=1.50, and k=0.00.

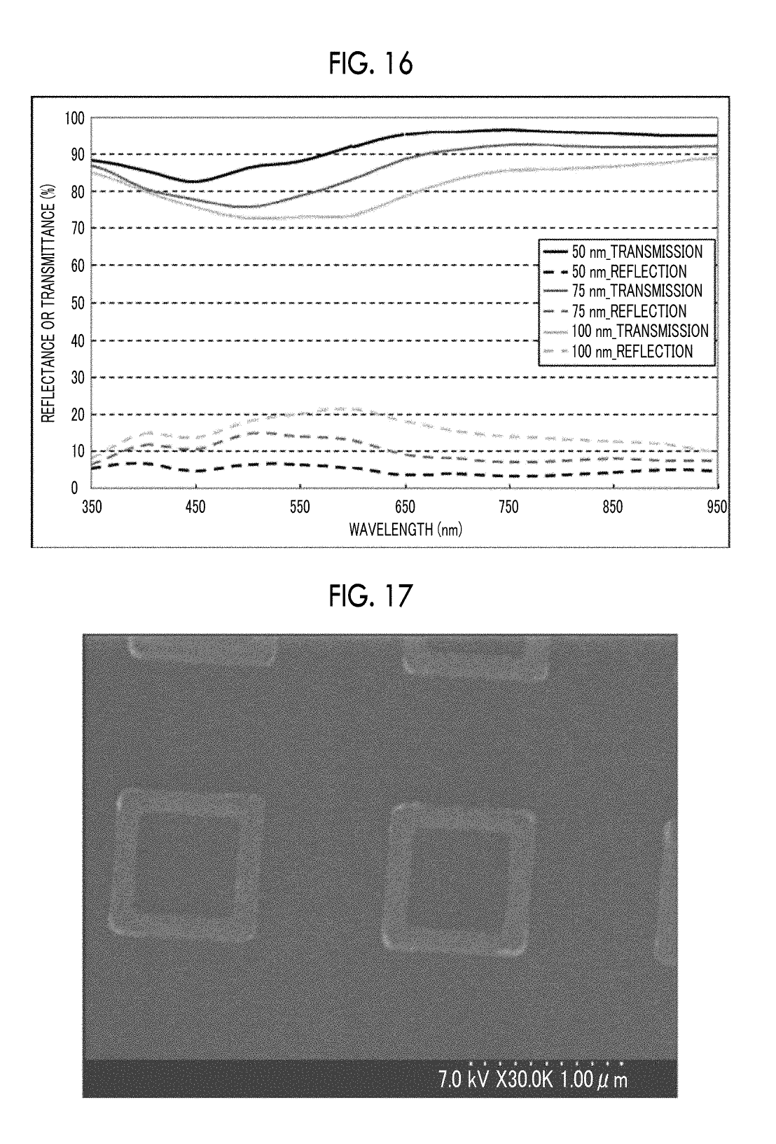

Calculation results thereof are presented in FIG. 16. The average transmittance of the visible range of Particles R8 to R10 was as presented in Table 6.

TABLE 6

| | | Average transmittance of |
|---|---|---|
| Particle | Aspect ratio | visible range (%) |
| R8 | 1 | 90.5 |
| R9 | 1.5 | 84.7 |
| R10 | 2 | 79.3 |

In FIG. 16 and Table 6, it was understood that in a case where R8 (aspect ratio: 1), R9 (aspect ratio: 1.5), and R10 (aspect ratio: 2) were compared with each other, as the aspect ratio increases, the transmittances at a wavelength of 350 nm to 800 nm were decreased.

From this, it is understood that as the aspect ratio of the cross section of the flat sheet-like metal particles having holes is smaller, transparency becomes more excellent.

From the above simulation results, it is understood that the infrared shielding material having the metal particle containing layer containing the flat sheet-like metal particles having holes had the high reflectance of far-infrared rays, the transparency, and the radio wave transmitting properties.

### Example 5

The change of the optical characteristics of the flat sheet-like metal particles having holes depending on the diameter of the particle was calculated by an electromagnetic field optical simulation FDTD method.

Transmittances at a wavelength of 350 nm to 950 nm were calculated by increments of 50 nm by the FDTD method, and the average value at a wavelength of 350 nm to 800 nm was taken as the average transmittance of the visible range.

The conditions of the flat sheet-like metal particles having holes used for calculation are as follows.

Particle R11

Shape: Ring shape

Cross-sectional shape: Square

Particle diameter: 1,000 nm

Particle thickness: 50 nm

Particle line width: 50 nm

Aspect ratio: 1

Hole area ratio: 90%

Surface density of flat sheet-like metal particle having hole: 50%

Most adjacent inter-metal particle distance: 0.2 μm

Coefficient of variation: 0%

Particle R12

Shape: Ring shape

Cross-sectional shape: Square

Particle diameter: 1,900 nm

Particle thickness: 50 nm

Particle line width: 50 nm

Aspect ratio: 1

Hole area ratio: 95%

Surface density of flat sheet-like metal particle having hole: 50%

Most adjacent inter-metal particle distance: 0.2 μm

Coefficient of variation: 0%

The most adjacent inter-particle distances of Particles R11 and R12 were set such that the metal particles were not in contact with each other and uniformly arranged.

The surrounding medium was set to n=1.50, and k=0.00.

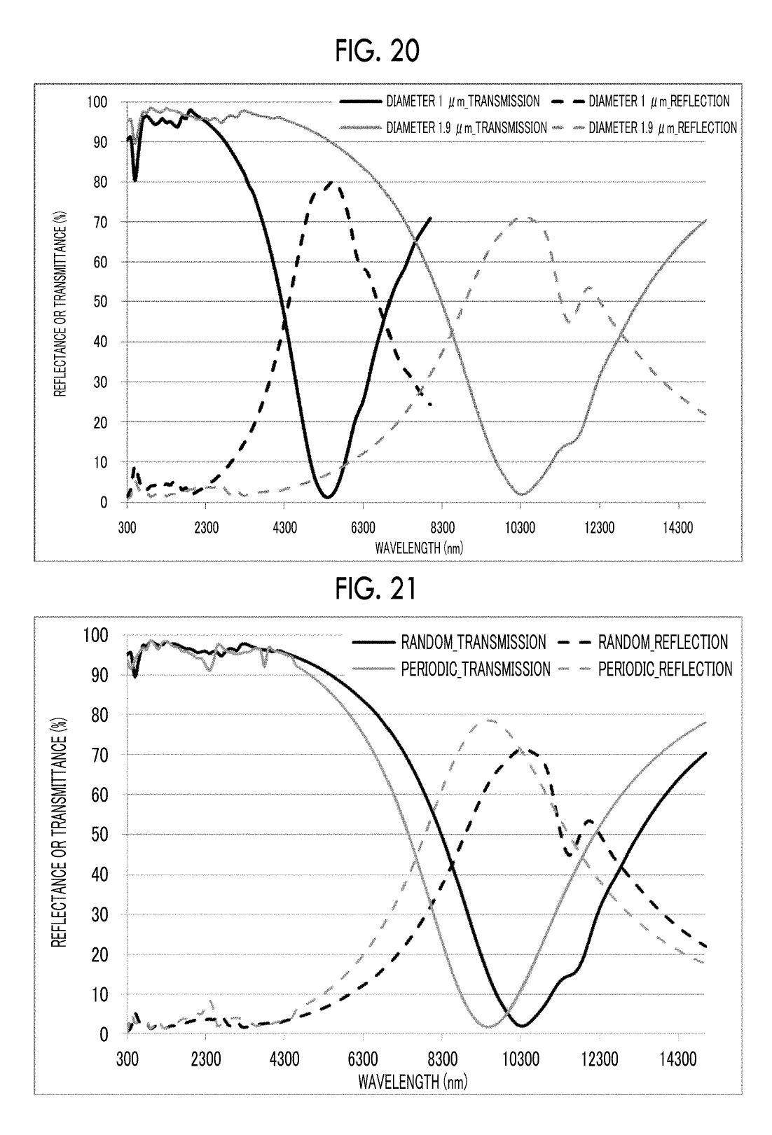

Calculation results thereof are presented in FIG. 20. The average transmittance of the visible range of Particles R11 and R12 was as presented in Table 7.

TABLE 7

| | | Average transmittance of |
|---|---|---|
| Particle | Diameter (μm) | visible range (%) |
| R11 | 1 | 90.3 |
| R12 | 1.9 | 94.6 |

In FIG. 20 and Table 7, it is understood that as the particle diameter is increased, the wavelength (peak wavelength) exhibiting the maximum reflection in the infrared range shifts to the longer wavelength side.

From this, it is understood that as the diameter of the flat sheet-like metal particles having holes is larger, the desired wavelength may be increased.

### Example 6

The change of the optical characteristics of the flat sheet-like metal particles having holes depending on the arrangement state of the particle was calculated by an electromagnetic field optical simulation FDTD method. The arrangement state was the random arrangement and the periodic arrangement.

Transmittances at a wavelength of 350 nm to 950 nm were calculated by increments of 50 nm by the FDTD method, and the average value at a wavelength of 350 nm to 800 nm was taken as the average transmittance of the visible range.

The conditions of the flat sheet-like metal particles having holes used for calculation are as follows. As the random arrangement, Particle R12 described above was used.

Particle R12

Shape: Ring shape

Cross-sectional shape: Square

Particle diameter: 1,900 nm

Particle thickness: 50 nm

Particle line width: 50 nm

Aspect ratio: 1

Hole area ratio: 95%

Surface density of flat sheet-like metal particle having hole: 50%

Most adjacent inter-metal particle distance: 0.2 μm

Coefficient of variation: 0%

Arrangement: Random

Particle R13

Shape: Ring shape

Cross-sectional shape: Square

Particle diameter: 1,900 nm

Particle thickness: 50 nm

Particle line width: 50 nm

Aspect ratio: 1

Hole area ratio: 95%

Surface density of flat sheet-like metal particle having hole: 50%

Most adjacent inter-metal particle distance: 0.5 μm

Coefficient of variation: 0%

Arrangement: Periodic

The most adjacent inter-particle distance of Particle R12 was set such that the metal particles were not in contact with each other and uniformly arranged.

The surrounding medium was set to n=1.50, and k=0.00.

Calculation results thereof are presented in FIG. 21. The average transmittance of the visible range of Particles R12 and R13 were as presented in Table 8.

TABLE 8

| | | Average transmittance of |
|---|---|---|
| Particle | Arrangement | visible range (%) |
| R12 | Random | 94.6 |
| R13 | Periodic | 94.8 |

In FIG. 21 and Table 8, it was understood that in a case where the particle arrangement was random, the transmittances at a wavelength of 350 nm to 800 nm were increased. It is assumed that, in a case where the particle arrangement is random, phases of the scattered light from respective particles vary and thus the light was cancelled by each other, so as to be reduced.

From this, it is understood that the random arrangement of the flat sheet-like metal particles having holes causes the transparency to be more excellent.

The change of the optical characteristics of the flat sheet-like metal particles having holes depending on the shape of the particle was calculated by an electromagnetic field optical simulation FDTD method.

Transmittances at a wavelength of 350 nm to 950 nm were calculated by increments of 50 nm by the FDTD method, and the average value at a wavelength of 350 nm to 800 nm was taken as the average transmittance of the visible range.

The conditions of the flat sheet-like metal particles having holes used for calculation are as follows.

Particle R15

Shape: Ring shape

Cross-sectional shape: Square

Particle diameter: 1,000 nm

Particle thickness: 50 nm

Particle line width: 150 nm

Hole area ratio: 50%

Surface density of flat sheet-like metal particle having hole: 25%

Most adjacent inter-metal particle distance: 0.8 μm

Coefficient of variation: 0%

Arrangement: Periodic

Particle R16

Shape: Square

Cross-sectional shape: Square

Particle diameter (one side): 1,000 nm

Particle thickness: 50 nm

Particle line width: 150 nm

Hole area ratio: 50%

Surface density of flat sheet-like metal particle having hole: 25%

Most adjacent inter-metal particle distance: 1.0 μm

Coefficient of variation: 0%

Arrangement: Periodic

The surrounding medium was set to n=1.50, and k=0.00.

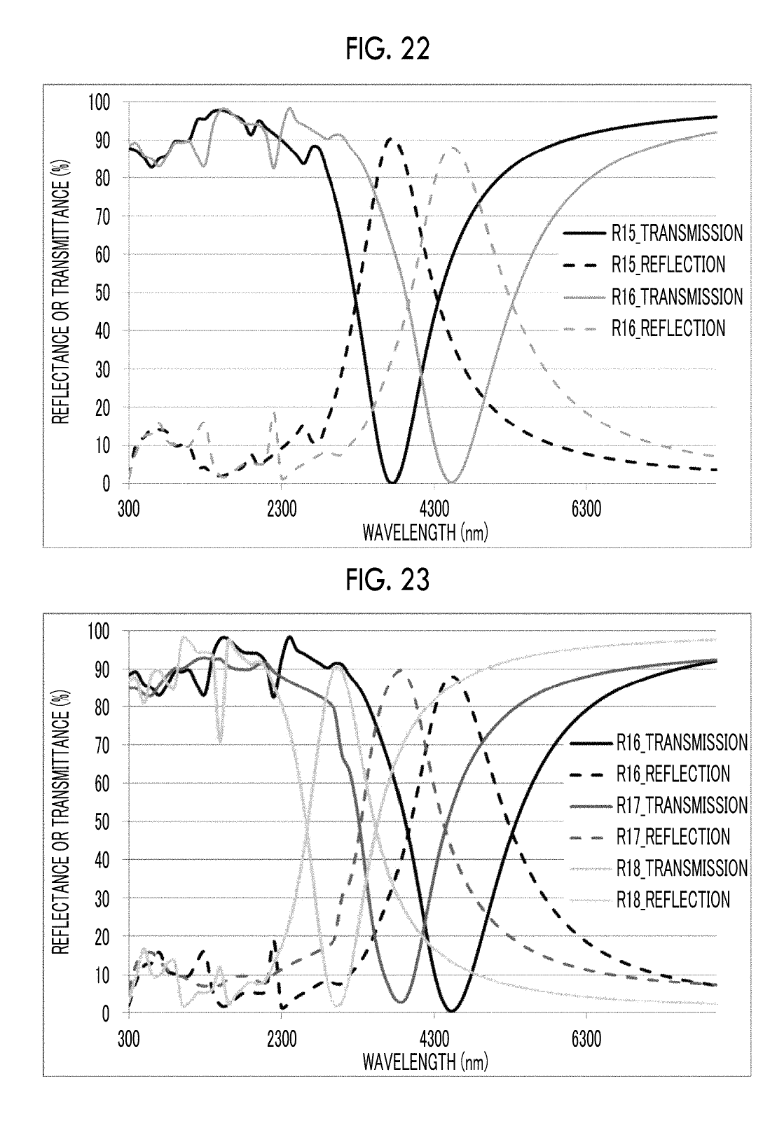

Calculation results thereof are presented in FIG. 22. The average transmittance of the visible range of Particles R15 and R16 was as presented in Table 9.

TABLE 9

| | | Average transmittance of |
|---|---|---|
| Particle | Shape | visible range (%) |
| R15 | Ring shape | 85.0 |
| R16 | Square | 85.3 |

In FIG. 22 and Table 9, it is understood that particles having a wavelength (peak wavelength) exhibiting the maximum reflection in the infrared range may be obtained even in a case where the particle shape is different. In the case of particles having the same diameter, it is understood that it is possible to shift the wavelength (peak wavelength) exhibiting the maximum reflection in the infrared range to the longer wavelength side by setting the shape to be square. This is assumed that the outer circumference length of the square shape of the particle is longer than that of the ring shape. However, in the case of a square, it is understood that there are some new resonance peaks on the shorter wavelength side. This is assumed that the influence of plasmon resonance occurring in the region of one side of a square with respect to incidence rays appeared because the particle shape had a shape with sides.

### Example 7

The change of the optical characteristics of the flat sheet-like metal particles having holes depending on the refractive index of the surrounding medium of the particle was calculated by an electromagnetic field optical simulation FDTD method.

Transmittances at a wavelength of 350 nm to 950 nm were calculated by increments of 50 nm by the FDTD method, and the average value at a wavelength of 350 nm to 800 nm was taken as the average transmittance of the visible range.

The conditions of the flat sheet-like metal particles having holes used for calculation are as follows.

Particle R16

Shape: Square

Cross-sectional shape: Square

Particle diameter (one side): 1,000 nm

Particle thickness: 50 nm

Particle line width: 150 nm

Hole area ratio: 50%

Surface density of flat sheet-like metal particle having hole: 25%

Most adjacent inter-metal particle distance: 1.0 μm

Coefficient of variation: 0%

Arrangement: Periodic

Refractive index of medium: Range I, n=1.50, k=0.00/Range II, n=1.50, k=0.00

Particle R17

Shape: Square

Cross-sectional shape: Square

Particle diameter (one side): 1,000 nm

Particle thickness: 50 nm

Particle line width: 150 nm

Hole area ratio: 50%

Surface density of flat sheet-like metal particle having hole: 25%

Most adjacent inter-metal particle distance: 1.0 μm

Coefficient of variation: 0%

Arrangement: Periodic

Refractive index of medium: Range I, n=1.00, k=0.00/Range II, n=1.50, k=0.00

Particle R18

Shape: Square

Cross-sectional shape: Square

Particle diameter (one side): 1,000 nm

Particle thickness: 50 nm

Particle line width: 150 nm

Hole area ratio: 50%

Surface density of flat sheet-like metal particle having hole: 25%

Most adjacent inter-metal particle distance: 1.0 μm

Coefficient of variation: 0%

Arrangement: Periodic

Refractive index of medium: Range I, n=1.00, k=0.00/Range II, n=1.00, k=0.00

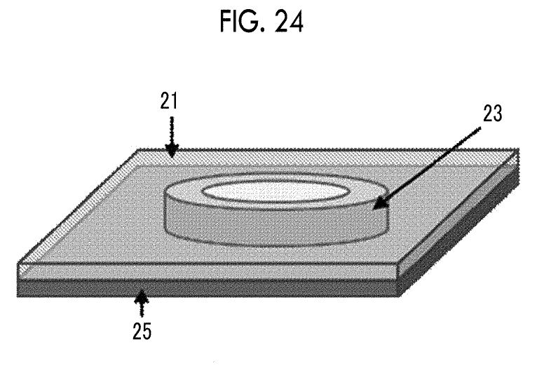

Calculation results thereof are presented in FIG. 23. The average transmittance of the visible range and the wavelength (peak wavelength) exhibiting the maximum reflection in the infrared range of Particles R16 and R18 were as presented in Table 10. In Table 10, for Particle 23 illustrated in FIG. 24, Range 21 illustrated in FIG. 24 is “Range I”, and Range 25 illustrated in FIG. 24 is “Range II”.

TABLE 10

| | | | Average | Peak |
|---|---|---|---|---|
| | | | transmittance | wave- |
| | Refractive index of medium | | of visible | length |
| Particle | Range I | Range II | range (%) | (nm) |
| R16 | n = 1.50 k = 0.00 | n = 1.50 k = 0.00 | 85.3 | 4500 |
| R17 | n = 1.00 k = 0.00 | n = 1.50 k = 0.00 | 84.8 | 3900 |
| R18 | n = 1.00 k = 0.00 | n = 1.00 k = 0.00 | 86.2 | 3000 |

In FIG. 23 and Table 10, it is understood that a wavelength (peak wavelength) exhibiting the maximum reflection in the infrared range was able to be shifted by changing the refractive index of the surrounding medium of the particle.

From this, it is understood that it is possible to obtain an infrared shielding material having a desired peak wavelength performance based on the refractive index of the surrounding medium.

### EXPLANATION OF REFERENCES

1 metal portion
2 hole portion
10 flat sheet-like metal particle having hole
11 support
12 metal particle containing layer
21 Range I
23 particle
25 Range II
r1 radius of metal particle
r2 hole radius
t width of metal particle

What is claimed is:

1. An infrared shielding material, comprising a metal particle-containing layer comprising flat sheet-like metal particles each having at least one hole.

2. The infrared shielding material according to claim 1, wherein the metal particle-containing layer has an average value X_{AVE} of hole area ratios X each represented by the following Expression 1 of larger than 10% and less than 100%:
X=hole area/metal particle area×100 Expression 1
wherein, in Expression 1, X represents a hole area ratio, the hole area represents an area of the hole present in one flat sheet-like metal particle in a case where the flat sheet-like metal particle is viewed from a plane, and the metal particle area represents an area of one flat sheet-like metal particle in a case where the flat sheet-like metal particle is viewed from a plane.

3. The infrared shielding material according to claim 2, wherein the average value X_{AVE} of the hole area ratios X of the metal particle-containing layer is larger than 30% and less than 100%.

4. The infrared shielding material according to claim 2, wherein the metal particle-containing layer has a surface density Y represented by the following Expression 2 and the average value X_{AVE} of the hole area ratios X satisfying the relationship represented by the following Expression 3:
Y=(total value of metal particle areas included in unit area)/(unit area)×100 Expression 2
wherein, in Expression 2, Y represents a surface density, and the metal particle areas each represent an area of one flat sheet-like metal particle in a case where the flat sheet-like metal particle is viewed from a plane:
Y≤0.75X_{AVE}+42.5 Expression 3.

5. The infrared shielding material according to claim 4, wherein the surface density Y and the average value X_{AVE} of the hole area ratios X of the metal particle-containing layer satisfy the relationship represented by the following Expression 4:
Y≤0.75X_{AVE}+32.5 Expression 4.

6. The infrared shielding material according to claim 4, wherein the surface density Y of the metal particle-containing layer is larger than 10% and less than 100%.

7. The infrared shielding material according to claim 4, wherein the surface density Y of the metal particle-containing layer is larger than 30% and less than 100%.

8. The infrared shielding material according to claim 1, wherein a coefficient of variation in particle diameter distribution of the flat sheet-like metal particles is 30% or less.

9. The infrared shielding material according to claim 1, wherein a cross section of one flat sheet-like metal particle in a case where the flat sheet-like metal particle is cut in a direction perpendicular to a principal plane thereof has an elliptical shape or a perfect circle shape.

10. The infrared shielding material according to claim 1, wherein an aspect ratio of a cross section of one flat sheet-like metal particle in a case where the flat sheet-like metal particle is cut in a direction perpendicular to a principal plane is 2.0 or less.

11. The infrared shielding material according to claim 1, wherein the flat sheet-like metal particles comprise at least silver.

12. The infrared shielding material according to claim 1, wherein, among the flat sheet-like metal particles, particles of which the principal planes are plane-aligned in a range of an average of 0°±30° with respect to one surface of the metal particle-containing layer are 50% by number of all flat sheet-like metal particles each having at least one hole.

13. The infrared shielding material according to claim 1, wherein a proportion of flat sheet-like metal particles each having at least one hole with respect to the total metal particles in the metal particle-containing layer is 60% by number or more.

14. The infrared shielding material according to claim 1, wherein a maximum value of a reflectance is in a wavelength range of from 0.78 μm to 1 mm.

15. The infrared shielding material according to claim 1, wherein a maximum value of a reflectance is in a wavelength range of from 3 μm to 1 mm.

16. The infrared shielding material according to claim 1, wherein a shape of one flat sheet-like metal particle in a case where the flat sheet-like metal particle is viewed from a plane is a polygonal shape of hexagon or higher polygon, or a circular shape.

17. The infrared shielding material according to claim 1, wherein a shape of one flat sheet-like metal particle in a case where the flat sheet-like metal particle is viewed from a plane is a circular shape.

18. The infrared shielding material according to claim 1, wherein a shape of the hole in one flat sheet-like metal particle in a case where the flat sheet-like metal particle is viewed from a plane is a circular shape.

19. The infrared shielding material according to claim 1, wherein the number of holes included in one flat sheet-like metal particle is one.

20. The infrared shielding material according to claim 1, wherein a centroid of an entire flat sheet-like metal particle and a centroid of a hole in a case where one flat sheet-like metal particle is viewed from a plane are overlapped with each other.

21. The infrared shielding material according to claim 1, wherein the flat sheet-like metal particles are randomly arranged in the metal particle-containing layer.

22. The infrared shielding material according to claim 1, wherein an average particle diameter of the flat sheet-like metal particles is from 175 nm to 200 μm.
